(19) United States
(12) Patent Application Publication
(10) Pub. No.: US 2020/0017726 A1
(43) Pub. Date: Jan. 16, 2020

(54) PRESSURE-SENSITIVE ADHESIVE SHEET AND PRESSURE-SENSITIVE ADHESIVE COMPOSITION

(71) Applicant: NITTO DENKO CORPORATION, Osaka (JP)

(72) Inventors: Toshiki Ikami, Ibaraki-shi (JP); Naoaki Higuchi, Ibaraki-shi (JP); Kenta Jozuka, Ibaraki-shi (JP)

(73) Assignee: NITTO DENKO CORPORATION, Osaka (JP)

(21) Appl. No.: 16/505,814

(22) Filed: Jul. 9, 2019

(30) Foreign Application Priority Data
Jul. 10, 2018 (JP) 2018-131122

(51) Int. Cl. C09J 7/38; C09J 11/08; C09J 7/26; B32B 7/12; G06F 3/041

(52) U.S. Cl. CPC C09J 7/385; C09J 11/08; C09J 7/26; B32B 7/12; G06F 3/041; B32B 2457/208; C09J 2433/00; C09J 2461/00; C09J 2400/243; C09J 2203/326; C09J 2205/102

(57) ABSTRACT

Provided is a PSA sheet that provides reliable adhesion even upon contact with grease. Provided is an adhesively double-faced PSA sheet having a PSA layer. The PSA sheet has an initial push-peel strength of 0.5 MPa or greater. It has an adhesive strength retention rate of 25% or higher, determined as the ratio of the push-peel strength at 24 hours after artificial sebum application to the push-peel strength before the artificial sebum application.

### CROSS-REFERENCE

This application claims priority to Japanese Patent Application No. 2018-131122 filed on Jul. 10, 2018 and the entire content thereof is incorporated herein by reference.

### BACKGROUND OF THE INVENTION

### 1. Field of the Invention

The present invention related to a pressure-sensitive adhesive sheet and a pressure-sensitive adhesive composition. In particular, it relates to a pressure-sensitive adhesive sheet suitable for fastening a component of a portable device and a pressure-sensitive adhesive composition suitable for preparing the pressure-sensitive adhesive sheet.

### 2. Description of the Related Art

In general, pressure-sensitive adhesive (PSA) exists as a soft solid (a viscoelastic material) in a room temperature range and has a property to adhere easily to an adherend with some pressure applied. With such properties, PSA is widely used, typically in forms of PSA sheets, for purposes such as bonding, fastening and protecting components of mobile phones and other portable devices. Technical documents related to adhesively double-faced PSA tapes used for fastening components of portable electronics include Japanese Patent Application Publication Nos. 2009-215355 and 2013-100485 and Japanese Patent Nos. 6153635 and 6113889.

### SUMMARY OF THE INVENTION

Portable devices are carried around for use and thus are susceptible to accumulation of grease from foods, skin secretion such as sebum and hand oils, and chemicals such as cosmetics, hair styling products, moisturizing cream, and sunscreens. Especially, portable touch-panel devices that have recently gained significant popularity often accumulate grease such as sebum via fingertips because they have screens (display/input members) serving as both displays (outputs) and input devices and surfaces of the screens are directly touched by user's fingertips for operation. Some so-called wearable devices are worn directly on the skin and are often exposed to grease such as sebum and chemicals put on the skin. For instance, in such an application, when the PSA layer of a PSA sheet fastening a component is touched with such grease (sebum, cosmetics, etc.), the PSA absorbs the grease and softens, possibly giving rise to issues such as swelling, deformation and degradation of cohesive strength. With respect to this issue, in Japanese Patent No. 6153635, studies have been conducted by the present inventors on a PSA sheet that is less susceptible to degradation of adhesive strength and squeezing out of the PSA upon oil penetration. In addition, Japanese Patent No. 6113889 suggests a PSA sheet that combines grease resistance and an ability to hold a component in a fixed position (holding properties).

However, as the development of portable devices (particularly portable electronics) proceeds with broadening in form and use, higher levels of performance are required of PSA sheets used for fastening their components. As a result of further studies by the present inventors, a PSA of higher performance has been successfully made to complete the present invention, with the PSA being capable of exhibiting sufficient holding properties not only in a normal state, but also after touched with grease. In other words, an objective of this invention is to provide a PSA sheet that shows reliable adhesion even when touched with grease. Another related objective is to provide a PSA composition used preferably for preparing the PSA sheet.

The present description provides an adhesively double-faced PSA sheet having a PSA layer. The PSA sheet has an initial push-peel strength of 0.5 MPa or greater. It has an adhesive strength retention rate of 25% or higher, determined as the ratio of the push-peel strength at 24 hours after artificial sebum application to the push-peel strength before the artificial sebum application (i.e. the percent adhesive strength retained at 24 hours after artificial sebum application). The PSA sheet having such initial push-peel strength can provide sufficient adhesive strength, for instance, in fastening and bonding components. Because it shows at least the prescribed adhesive strength retention rate even after touched with artificial sebum, it can achieve reliable adhesion (grease-resistant adhesion) even when touched with grease.

As used herein, the term “grease” comprehensively refers to oil and fats contained in sebum, chemicals such as cosmetics, foods, etc.

In a preferable embodiment of the PSA sheet disclosed herein, the initial push-peel strength is 1 MPa or greater and the adhesive strength retention rate (the % adhesive strength retained shown as the ratio of the push-peel strength at 24 hours after artificial sebum application to the push-peel strength before the sebum application) is 50% or higher. Such an embodiment can achieve highly reliable grease-resistant adhesion.

In a preferable embodiment of the PSA sheet disclosed herein, the PSA layer comprises an acrylic polymer as the base polymer. In an embodiment using an acrylic polymer as the base polymer of the PSA layer, the reliable grease-resistant adhesion is preferably obtained.

In a preferable embodiment of the PSA sheet disclosed herein, the PSA layer comprises a tackifier resin having a hydroxyl value of 120 mgKOH/g or greater. The use of the tackifier resin having a hydroxyl value of 120 mgKOH/g or greater can preferably improve the grease resistance while ensuring adhesive properties such as adhesive strength and holding properties.

In a preferable embodiment of the PSA sheet disclosed herein, the tackifier resin comprises a phenolic tackifier resin. The use of the phenolic tackifier resin as the tackifier resin preferably brings about the effect of the art disclosed herein.

In a preferable embodiment of the PSA sheet disclosed herein, the tackifier resin content in the PSA layer is 10 parts by weight or greater and 60 parts by weight or less to 100 parts by weight of the base polymer in the PSA layer. When the tackifier resin is used in an amount of at least 10 parts by weight to 100 parts by weight of the base polymer, good adhesive strength is likely to be obtained. When the tackifier resin is used in an amount of 60 parts by weight or less to 100 parts by weight of the base polymer, it blends well with the base polymer and good adhesive properties are likely to be obtained.

The PSA sheet according to a preferable embodiment has a substrate layer supporting the PSA layer. Such a substrate-supported double-faced PSA sheet is configured as a double-faced PSA sheet having the PSA layer on one (first) face and the substrate layer on the other (second) face. The double-faced PSA sheet is used in a manner that each of the two faces of the PSA sheet is applied to an adherend; and therefore, grease is likely to penetrate the adhesive interface with the adherend. Thus, it is particularly meaningful to increase the grease resistance by applying the art disclosed herein. The substrate layer more preferably comprises a resin film layer or a foam layer.

For instance, the PSA sheet disclosed herein can be preferably used for bonding components of a portable electronic device. As described above, portable electronics are often touched with grease. Thus, it is particularly beneficial to increase the grease resistance by applying the art disclosed herein.

The present description also provides a PSA composition. The PSA composition comprises an acrylic polymer as the base polymer and a tackifier resin. The tackifier resin comprises a tackifier resin having a hydroxyl value of 120 mgKOH/g or greater. By using a PSA composition having such a composition, a PSA sheet highly reliable in forming grease-resistant adhesion can be preferably prepared.

### BRIEF DESCRIPTION OF THE DRAWINGS

FIG. 1 shows a cross-sectional diagram schematically illustrating a structural example of the PSA sheet.

FIGS. 2(a) and (b) show a schematic drawing of a test sample used for measurement of push-peel strength, FIG. 2(a) showing a top view and 2(b) showing a cross-sectional view taken along line A-A′ in FIG. 2(a).

FIG. 3 shows a diagram illustrating the method for determining push-peel strength.

FIG. 4 shows a cross-sectional diagram to illustrate the method for applying artificial sebum in evaluation of push-peel strength after application of artificial sebum.

FIGS. 5(a) and (b) show a diagram illustrating a test sample used in a drop impact resistance test, FIG. 5(a) showing a top view and 5(b) showing a cross-sectional view taken along line B-B′ in FIG. 5(a).

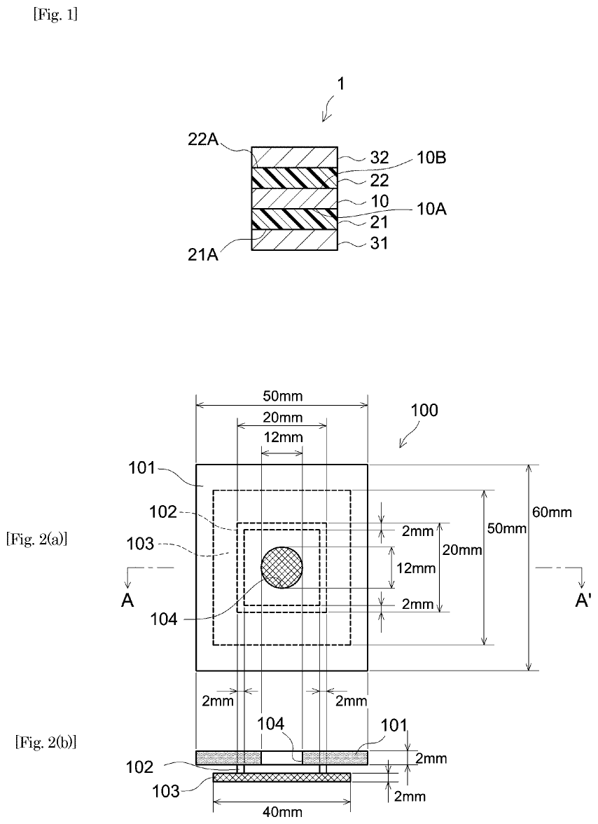

### DETAILED DESCRIPTION OF THE INVENTION

Preferred embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

As used herein, the term “PSA” refers to, as described earlier, a material that exists as a soft solid (a viscoelastic material) in a room temperature range and has a property to adhere easily to an adherend with some pressure applied. As defined in “Adhesion Fundamental and Practice” by C. A. Dahlquist (McLaren & Sons (1966), P. 143), PSA referred to herein may generally be a material that has a property satisfying complex tensile modulus E*(1 Hz)<10⁷ dyne/cm² (typically, a material that exhibits the described characteristics at 25° C.).

### <Constitution of PSA Sheet>

The PSA sheet (possibly in a long form such as tape) is an adhesively double-faced PSA sheet comprising a PSA layer. It can be a substrate-supported double-faced PSA sheet or a substrate-free double-faced PSA sheet. The concept of PSA sheet herein encompasses so-called PSA tapes, PSA labels, PSA films and the like. The PSA sheet disclosed herein may be in a rolled form or in a flat sheet form. The PSA sheet may be further processed into various forms.

For instance, the PSA sheet disclosed herein may have a cross-sectional structure as schematically illustrated in FIG. 1. PSA sheet 1 has a support substrate 10 as well as first and second PSA layers 21 and 22 supported on first and second faces 10A and 10B of support substrate 10, respectively. Both first and second faces 10A and 10B have non-releasable surfaces (non-release faces). For use of PSA sheet 1, the surfaces (first and second adhesive faces) 21A and 22A of first and second PSA layers 21 and 22 are applied to adherends, respectively. PSA sheet 1 prior to use is in an embodiment where first and second adhesive faces 21A and 22A are protected with release liners 31 and 32 having releasable surfaces (release faces) at least on their PSA-facing sides. In an alternative embodiment, release liner 32 is omitted; and using a release liner 31 having a release face on each side, PSA sheet 1 can be wound to protect the second adhesive face 22A with the backside of release liner 31 brought in contact therewith. Alternatively, the PSA sheet disclosed herein may be a substrate-free double-faced PSA sheet formed solely of the PSA layer although no drawing is shown in particular.

### <Properties of PSA Sheet>

The PSA sheet disclosed herein is characterized by exhibiting an initial push-peel strength of 0.5 MPa or greater. With such high initial push-peel strength, the PSA sheet is highly reliable in adhesion. For instance, it may provide sufficient adhesive strength in fixing and bonding components. Even in an embodiment where the PSA sheet having a narrow width is applied to an adherend, it is less susceptible to peeling caused by internal stress. The initial push-peel strength is preferably about 0.7 MPa or greater, more preferably about 0.9 MPa or greater, yet more preferably about 1.0 MPa or greater, or particularly preferably about 1.2 MPa or greater (e.g. 1.3 MPa or greater). The initial push-peel strength is determined by the method described later in Examples.

The PSA sheet disclosed herein is also characterized by having an adhesive strength retention rate of 25% or higher, determined as the ratio of push-peel strength S2 at 24 hours after artificial sebum application to push-peel strength S1 before the artificial sebum application. The PSA sheet satisfying this property has at least certain adhesive strength even after artificial sebum application; and therefore, it provides reliable adhesion even when touched with grease. The adhesive strength retention rate after artificial sebum application is preferably about 40% or higher, more preferably about 50% or higher, yet more preferably about 60% or higher, or particularly preferably about 70% or higher (e.g. about 75% or higher, or even about 80% or higher). The adhesive strength retention rate (%) after artificial sebum application is determined by the formula S2/S1×100. The initial push-peel strength S1 before artificial sebum application is the aforementioned initial push-peel strength (MPa) and the push-peel strength S2 at 24 hours after artificial sebum application is determined by the method described later in Examples.

The PSA sheet disclosed herein suitably has a 24-h push-peel strength (post-sebum-application adhesive strength) S2 of about 0.3 MPa and greater (e.g. about 0.4 MPa or greater). The PSA sheet satisfying this property has at least certain adhesive strength even after artificial sebum application; and therefore, it may provide good adhesive strength even when used in an environment exposed to grease. The post-sebum-application adhesive strength is preferably about 0.5 MPa or greater (e.g. about 0.6 MPa or greater), more preferably about 0.7 MPa or greater, yet more preferably about 0.8 MPa or greater, or particularly preferably about 1 MPa or greater (e.g. about 1.1 MPa or greater).

The PSA sheet according to a preferable embodiment has a 180° peel strength of about 10 N/20 mm or greater. The PSA sheet showing such adhesive strength achieves highly tight adhesion to an adherend; and therefore, it may provide excellent resistance to grease penetration via the interface between the PSA layer and adherend. The 180° peel strength is more preferably about 15 N/20 mm or greater, or yet more preferably about 17 N/20 mm or greater (e.g. about 18 N/20 mm or greater). From the standpoint that the tighter the adhesion to the adherend, the better, while the maximum 180° peel strength is not particularly limited, it is usually about 65 N/20 mm or less (typically about 55 N/20 mm or less, e.g. about 40 N/20 mm or less). The 180° peel strength is determined by the method described later in Examples.

### <PSA Layer>

### (Base Polymer)

In the art disclosed herein, the type of PSA forming the PSA layer is not particularly limited. The PSA may comprise, as the base polymer, one, two or more species selected among various polymers (adhesive polymers) such as acrylic, polyester-based, urethane-based, polyether-based, rubber-based, silicone-based, polyamide-based and fluorine-based polymers. In a preferable embodiment, the primary component of the PSA layer is an acrylic PSA. The art disclosed herein can be preferably implemented in an embodiment of a PSA sheet having a PSA layer essentially formed of an acrylic PSA. The “base polymer” of a PSA refers to the primary component among the rubbery polymers (typically polymers that exhibit rubber elasticity in a room temperature range) in the PSA. As used herein, the “primary component” refers to a component accounting for more than 50% by weight of the content unless otherwise noted. The description provided below about possible components of the PSA and PSA layer can be applied to the PSA composition used for forming the PSA (layer) unless otherwise informed.

As used herein, the term “acrylic PSA” refers to a PSA whose base polymer is an acrylic polymer. The base polymer is the primary component among the polymers contained, that is, the component accounting for 50% by weight or more. The term “acrylic polymer” refers to a polymer comprising, as a monomeric unit constituting the polymer, a monomeric unit derived from a monomer having at least one (meth)acryloyl group per molecule. Hereinafter, a monomer having at least one (meth)acryloyl group per molecule is referred to as “acrylic monomer” as well. Accordingly, the acrylic polymer is defined as a polymer comprising a monomeric unit derived from an acrylic monomer. As used herein, the term “(meth)acryloyl” comprehensively refers to acryloyl and methacryloyl. Similarly, the term “(meth)acrylate” comprehensively refers to acrylate and methacrylate, and the term “(meth)acryl” comprehensively refers to acryl and methacryl.

Although the acrylic PSA is described specifically below, the art disclosed herein is not limited to an embodiment using an acrylic PSA.

### (Acrylic Polymer)

A preferable example of the acrylic polymer is a polymer of starting monomer(s) comprising an alkyl (meth)acrylate as the primary monomer and possibly further comprising a secondary monomer copolymerizable with the primary monomer. The primary monomer here refers to a component that accounts for more than 50% by weight of the monomer composition of the starting monomer(s).

As the alkyl (meth)acrylate, for instance, a compound represented by the following general formula (1) can be used:

CH₂═C(R¹)COOR² (1)

Herein, R¹ in the formula (1) is a hydrogen atom or a methyl group. R² is an acyclic alkyl group having 1 to 20 carbon atoms. Hereinafter, such a range of the number of carbon atoms may be indicated as C₁₋₂₀. From the standpoint of the storage elastic modulus of the PSA, etc., the primary monomer is suitably an alkyl (meth)acrylate having an acyclic C₁₋₁₄ (e.g. C₂₋₁₀ or C₄₋₈) alkyl group for R². From the standpoint of the adhesive properties, the primary monomer is preferably an alkyl acrylate having a hydrogen atom for R¹ and an acyclic C₄₋₈ alkyl group for R². Such an alkyl acrylate may be referred simply as a C₄₋₈ alkyl acrylate hereinafter.

Examples of the alkyl (meth)acrylate having a C₁₋₂₀ acyclic alkyl group for R² include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. These alkyl (meth)acrylates can be used singly as one species or in a combination of two or more species. Preferable alkyl (meth)acrylates include n-butyl acrylate (BA) and 2-ethylhexyl acrylate (2EHA).

The alkyl (meth)acrylate content in the total monomer content used in synthesizing the acrylic polymer is preferably 70% by weight or greater, more preferably 85% by weight or greater, or yet more preferably 90% by weight or greater. The upper limit of alkyl (meth)acrylate content is not particularly limited. It is usually suitably 99.5% by weight or less (e.g. 99% by weight or less). From the standpoint of obtaining favorable effect of a secondary monomer such as a carboxy group-containing monomer, it is preferably about 98% by weight or less (e.g. 97% by weight or less).

The acrylic polymer according to a preferable embodiment is a polymer of a monomer mixture that comprises a C₁₋₆ alkyl (meth)acrylate as the primary monomer and may further comprise a secondary monomer copolymerizable with the primary monomer. For the C₁₋₆ alkyl (meth)acrylate, solely one species or a combination of two or more species can be used.

The acrylic polymer whose primary monomer is a C₁₋₆ alkyl (meth)acrylate generally has lower lipophilicity as compared to an acrylic polymer whose primary monomer is an alkyl (meth)acrylate having an alkyl group with more carbon atoms at the ester terminus Thus, the PSA layer comprising such an acrylic polymer as the base polymer tends to be less likely to absorb grease.

From the standpoint of further lowering the PSA layer's lipophilicity, the primary monomer of the acrylic polymer is preferably a C₁₋₅ alkyl (meth)acrylate, or more preferably a C₁₋₄ alkyl (meth)acrylate. From the standpoint of the tightness of adhesion to the adherend, in the acrylic polymer according to a preferable embodiment, the primary monomer is a C₂₋₆ alkyl (meth)acrylate, or more preferably a C₄₋₆ alkyl (meth)acrylate. From the standpoint of increasing the tightness, in the acrylic polymer according to another preferable embodiment, the primary monomer is a C₁₋₆ alkyl acrylate, or more preferably a C₁₋₄ alkyl acrylate (e.g. a C₂₋₄ alkyl acrylate).

From the standpoint of lowering the lipophilicity of the PSA layer and increasing the tightness of adhesion to the adherend and substrate, a preferable C₁₋₆ alkyl (meth)acrylate has a homopolymer glass transition temperature (Tg) of about 20° C. or below (typically about 10° C. or below, preferably about 0° C. or below, more preferably about −10° C. or below, or yet more preferably about −15° C. or below). For instance, the art disclosed herein can be preferably implemented in an embodiment where the primary monomer of the acrylic polymer is BA.

From the standpoint of lowering the lipophilicity of the PSA layer, the ratio of C₁₋₆ alkyl (meth)acrylate (typically a C₁₋₆ alkyl acrylate, e.g. BA) in the monomers forming the acrylic polymer is preferably about 60% by weight or higher, more preferably about 75% by weight or higher, or yet more preferably about 85% by weight or higher. The art disclosed herein can be preferably practiced in an embodiment where, for instance, BA accounts for about 70% by weight or more (more preferably about 80% by weight or more, yet more preferably about 85% by weight or more, about 90% by weight or more, or even about 95% by weight or more) of the starting monomers.

In the acrylic polymer in the art disclosed herein, other monomers may be copolymerized as necessary besides those described above as long as the effects of this invention are not significantly impaired. The other monomers can be used for purposes such as adjusting the acrylic polymer's Tg, increasing the cohesive strength and adjusting the initial adhesive properties. Examples of a monomer capable of increasing the PSA's cohesive strength and heat resistance include sulfonate group-containing monomers, phosphate group-containing monomers, cyano group-containing monomers, vinyl esters, and aromatic vinyl compounds. Favorable examples among these include vinyl esters. Specific examples of vinyl esters include vinyl acetate (VAc), vinyl propionate and vinyl laurate. VAc is particularly preferable.

The other monomers capable of introducing a functional group as a possible crosslinking site into the acrylic polymer or of contributing to an increase in peel strength include hydroxy group-containing monomers, carboxy group-containing monomers, acid anhydride group-containing monomers, amide group-containing monomers, amino group-containing monomers, imide group-containing monomers, epoxy group-containing monomers, (meth)acryloylmorpholine, and vinyl ethers.

In a favorable acrylic polymer in the art disclosed herein, a carboxy group-containing monomer is copolymerized as the other monomer. This tends to bring about a PSA layer having high cohesive strength. The inclusion of the carboxy group-containing monomer in the monomers may advantageously contribute to tighter adhesion between the PSA layer and the adherend or substrate. Examples of the carboxy group-containing monomer include acrylic acid (AA), methacrylic acid (MAA), carboxyethyl (meth)acrylate, carboxypentyl (meth)acrylate, itaconic acid, maleic acid, fumaric acid, crotonic acid, and isocrotonic acid. Particularly preferable carboxy group-containing monomers include AA and MAA. AA is particularly preferable.

Other favorable examples of the acrylic polymer in the art disclosed herein include an acrylic polymer in which a hydroxy group-containing monomer is copolymerized as the other monomer. The hydroxy group-containing monomer can be copolymerized along with a carboxy group-containing monomer. Examples of the hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; polypropylene glycol mono(meth)acrylate; and N-hydroxyethyl(meth)acrylamide. A particularly preferable hydroxy group-containing monomer is a hydroxyalkyl (meth)acrylate having a hydroxy group at a terminus of a linear alkyl chain having about two to four carbon atoms.

For the other monomer(s), solely one species or a combination of two or more species can be used. The combined other monomer content can be, for instance, about less than 50% by weight (typically about 0.001% to 40% by weight) of the total monomer content; it is usually suitably about 25% by weight or greater (typically about 0.01% to 25% by weight, e.g. 0.1% to 20% by weight).

When a carboxy group-containing monomer is used as the other monomer, its amount is usually suitably about 0.1% by weight or more of the total monomer content; it is preferably about 0.2% by weight or more, more preferably about 0.5% by weight or more, yet more preferably about 1% by weight or more, or particularly preferably about 2% by weight or more (e.g. about 3% by weight or more). With increasing amount of carboxy group-containing monomer, the PSA layer's cohesive strength tends to increase in general. The amount of carboxy group-containing monomer is suitably about 20% by weight or less of the total monomer content; it is preferably about 15% by weight or less, more preferably about 12% by weight or less, yet more preferably about 10% by weight or less, or particularly preferably about 8% by weight or less (e.g. about 7% by weight or less). When the amount of carboxy group-containing monomer is in these ranges, a favorable PSA layer can be obtained, showing tight adhesion to the adherend and substrate. For instance, when a tackifier resin described later is added, the effect of its addition is suitably obtained.

When a hydroxy group-containing monomer is used as the other monomer, its amount is usually suitably about 0.001% by weight or more of the total monomer content; it is preferably about 0.01% by weight or more (typically about 0.02% by weight or more). The amount of hydroxy group-containing monomer is suitably about 10% by weight or less of the total monomer content, preferably about 5% by weight or less, or more preferably about 2% by weight or less.

The copolymer composition of the acrylic polymer is suitably designed so that the acrylic polymer has a Tg of suitably about −15° C. or below (typically about −70° C. or above and about −15° C. or below). Here, the acrylic polymer's Tg (the Tg of the acrylic polymer) refers to the Tg value determined by the Fox equation based on the composition of the monomers used in the synthesis of the polymer. As shown below, the Fox equation is a relational expression of the Tg of a copolymer and the glass transition temperatures Tgi of the homopolymers obtained by hemopolymerization of the monomers constituting the copolymer.

1/Tg=Σ(Wi/Tgi)

In the Fox equation above, Tg represents the glass transition temperature (unit: K) of the copolymer, Wi the weight fraction (copolymerization ratio by weight) of a monomer i in the copolymer, and Tgi the glass transition temperature (unit: K) of the homopolymer of the monomer i.

As for the glass transition temperatures of homopolymers used in determining the Tg, the values in known documents are used. For instance, with respect to the monomers listed below, as the glass transition temperatures of their corresponding homopolymers, the following values are used:

| | |
|---|---|
| 2-ethylhexyl acrylate | −70° C. |
| n-butyl acrylate | −55° C. |
| ethyl acrylate | −22° C. |
| methyl acrylate | 8° C. |
| methyl methacrylate | 105° C. |
| 2-hydroxyethyl acrylate | −15° C. |
| 4-hydroxybutyl acrylate | −40° C. |
| vinyl acetate | 32° C. |
| styrene | 100° C. |
| acrylic acid | 106° C. |
| methacrylic acid | 228° C. |

With respect to the Tg values of other homopolymers besides those exemplified above, the values given in “Polymer Handbook” (3rd edition, John Wiley & Sons, Inc., Year 1989) are used. When the literature provides two or more values for a certain monomer, the highest value is used.

With respect to monomers whose homopolymer glass transition temperatures are not listed in the reference book, values obtained by the following measurement method are used.

In particular, to a reaction vessel equipped with a thermometer, a stirrer, a nitrogen inlet and a condenser, are added 100 parts by weight of monomer(s), 0.2 part by weight of 2,2′-azobisisobutyronitrile, and 200 parts by weight of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature and a homopolymer solution having 33% by weight solid content is obtained. Then, this homopolymer solution is applied onto a release liner by flow coating and allowed to dry to prepare a test sample (a homopolymer sheet) of about 2 mm thickness. This test sample is cut out into a disc of 7.9 mm diameter and is placed between parallel plates. While applying a shear strain at a frequency of 1 Hz using a rheometer (trade name “ARES” available from TA Instruments), the viscoelasticity is measured in the shear mode over a temperature range of −70° C. to 150° C. at a heating rate of 5° C./min. The temperature corresponding to the peak top temperature of the tan δ curve is used as the homopolymer Tg.

While no particular limitations are imposed, from the standpoint of the tightness of adhesion to the adherend and substrate, the acrylic polymer has a Tg of advantageously about −25° C. or below, preferably about −35° C. or below, or more preferably about −40° C. or below. From the standpoint of the PSA layer's cohesive strength, the acrylic polymer's Tg is advantageously about −65° C. or above, preferably about −60° C. or above, or more preferably about −55° C. or above. The art disclosed herein can be preferably implemented in an embodiment where the acrylic polymer's Tg is about −65° C. or above and −35° C. or below (e.g. about −55° C. or above and −40° C. or below). The acrylic polymer's Tg can be adjusted by suitably changing the monomer composition (i.e. types and relative amounts of monomers used for the synthesis of the polymer).

The method for obtaining the acrylic polymer is not particularly limited. Various polymerization methods known as synthetic means for acrylic polymers can be suitably employed, with the methods including a solution polymerization method, emulsion polymerization method, bulk polymerization method, suspension polymerization method, photopolymerization method, etc. For instance, a solution polymerization method can be preferably used. As a method for supplying monomers when carrying out solution polymerization, can be suitably employed an all-at-once supply method to supply all starting monomers at once, continuous (dropwise) supply method, portionwise (dropwise) supply method, etc. The polymerization temperature can be suitably selected depending on the types of monomers and solvent being used, type of polymerization initiator, etc. For example, it can be about 20° C. to 170° C. (typically about 40° C. to 140° C.). In a preferable embodiment, the polymerization temperature can be about 75° C. or lower (more preferably about 65° C. or lower, e.g. about 45° C. to 65° C.).

The solvent (polymerization solvent) used for solution polymerization can be suitably selected among heretofore known organic solvents. For instance, one species of solvent or a mixture of two or more species of solvent can be used, selected from aromatic compounds (typically aromatic hydrocarbons) such as toluene; acetic acid esters such as ethyl acetate; aliphatic or alicyclic hydrocarbons such as hexane and cyclohexane; halogenated alkanes such as 1,2-dichloroethane; lower alcohols (e.g. monohydric alcohols with one to four carbon atoms) such as isopropanol; ethers such as tert-butyl methyl ether; and ketones such as methyl ethyl ketone.

The initiator used for the polymerization can be suitably selected from heretofore known polymerization initiators in accordance with the type of polymerization method. For instance, one, two or more species of azo-based polymerization initiator, such as 2,2′-azobisisobutylonitrile (AIBN) can be preferably used. Other examples of polymerization initiator include persulfate salts such as potassium persulfate, etc.; peroxide-based initiators such as benzoyl peroxide (BPO), hydrogen peroxide, etc.; substituted ethane-based initiators such as phenyl-substituted ethane, etc.; aromatic carbonyl compounds; and so on. Yet other examples of polymerization initiator include a redox-based initiator by a combination of a peroxide and a reducing agent. These polymerization initiators can be used singly as one species or in a combination of two or more species. The polymerization initiator can be used in a typical amount. For instance, it can be selected from a range of about 0.005 part to 1 part by weight (typically about 0.01 part to 1 part by weight) to 100 parts by weight of the total monomer content.

The solution polymerization yields a polymerization reaction mixture in a form such that an acrylic polymer is dissolved in an organic solvent. The PSA layer in the art disclosed herein may be formed from a PSA composition comprising the polymerization reaction mixture or an acrylic polymer solution obtained by subjecting the reaction mixture to a suitable work-up. For the acrylic polymer solution, the polymerization reaction mixture can be used after adjusted to suitable viscosity (concentration) as necessary. Alternatively, an acrylic polymer can be synthesized by a polymerization method (e.g. emulsion polymerization, photopolymerization, bulk polymerization, etc.) other than solution polymerization and an acrylic polymer solution prepared by dissolving the acrylic polymer in an organic solvent can be used as well.

In the art disclosed herein, the weight average molecular weight (Mw) of the base polymer (favorably an acrylic polymer) is not particularly limited. For instance, it can be in a range of 10×10⁴ to 500×10⁴. From the standpoint of the adhesive performance, the base polymer has a Mw of preferably 30×10⁴ or higher, more preferably about 45×10⁴ or higher (typically about 65×10⁴ or higher), and preferably about 200×10⁴ or lower, more preferably about 150×10⁴ or lower, or yet more preferably about 130×10⁴ or lower. The Mw herein refers to the value in terms of standard polystyrene determined by GPC (gel permeation chromatography). As the GPC system, for instance, a model name HLC-8320GPC (column: TSKgel GMH-H(S) available from Tosoh Corporation) can be used.

### (Tackifier Resin)

The PSA layer disclosed herein preferably comprises a tackifier resin in addition to the base polymer. As the tackifier resin, one, two or more species can be used, selected among various known tackifier resins such as rosin-based resins, terpene resins, modified terpene resins, phenolic resins, styrene-based resins, hydrocarbon-based tackifier resins, epoxy-based tackifier resins, polyamide-based tackifier resins, elastomer-based tackifier resins and ketone-based resins. Among them, phenolic tackifier resins are preferable.

Examples of the phenolic tackifier resin include terpene phenol resin, hydrogenated terpene phenol resin, alkylphenol resin and rosin-phenol resin.

The terpene phenol resin refers to a polymer comprising a terpene residue and a phenol residue, and its concept encompasses a copolymer of a terpene and a phenol compound (terpene phenol copolymer resin) as well as a terpene homopolymer or copolymer modified with a phenol (phenol-modified terpene resin). Favorable examples of a terpene forming such a terpene phenol resin include monoterpenes such as α-pinene, β-pinene, and limonene (including the D-isomer, L-isomer, and DL-limonene (dipentene)). The hydrogenated terpene phenol resin refers to a hydrogenated terpene phenol resin having a structure of such a terpene phenol resin with added hydrogen atoms. It is sometimes called hydrogenated terpene phenol resin.

The alkylphenol resin is a resin (oil-based phenol resin) obtainable from an alkylphenol and formaldehyde. Examples of the alkylphenol resin include a novolac type and a resol type.

The rosin-phenol resin is typically a resin obtainable by phenol modification of a rosin or one of the various rosin derivatives listed above (including a rosin ester, an unsaturated fatty acid-modified rosin and an unsaturated fatty acid-modified rosin ester). Examples of the rosin-phenol resin include a rosin-phenol resin obtainable by acid catalyzed addition of a phenol to a rosin or one of the various rosin derivatives listed above, followed by thermal polymerization.

The concept of rosin-based resin (rosin-based tackifier resin) herein encompasses both a rosin and a rosin-derived resin. However, a species considered as a rosin-phenol resin described later is treated as a phenolic resin instead of as a rosin-based resin.

Examples of a rosin include unmodified rosins (raw rosins) such as gum rosin, wood rosin, tall-oil rosin, etc.; modified rosins obtainable from these unmodified rosins via modifications such as hydrogenation, disproportionation, and polymerization (hydrogenated rosins, disproportionated rosins, polymerized rosins, and other chemically-modified rosins, etc.).

The rosin-derived resin is typically a derivative of a rosin as those listed above. The concept of rosin-based resin herein encompasses a derivative of an unmodified rosin and a derivative of a modified rosin (including a hydrogenated rosin, a disproportionated rosin, and a polymerized rosin).

Examples of a rosin-derived resin include rosin esters such as an unmodified rosin ester which is an ester of an unmodified rosin and an alcohol, and a modified rosin ester which is an ester of a modified rosin and an alcohol; an unsaturated fatty acid-modified rosin obtainable by modifying a rosin with an unsaturated fatty acid; an unsaturated fatty acid-modified rosin ester obtainable by modifying a rosin ester with an unsaturated fatty acid; rosin alcohols obtainable by reduction of carboxyl groups in rosins or aforementioned various rosin derivatives (including rosin esters, unsaturated fatty acid-modified rosin, and an unsaturated fatty acid-modified rosin ester); and metal salts of rosins or aforementioned various rosin derivatives.

Specific examples of a rosin ester include, but not limited to, a methyl ester, triethylene glycol ester, glycerin ester or pentaerythritol ester, etc., of an unmodified rosin or a modified rosin (hydrogenated rosin, disproportionated rosin, polymerized rosin, etc.).

Examples of a terpene resin (terpene-based tackifier resin) include terpenes (typically monoterpenes) such as α-pinene, β-pinene, D-limonene, L-limonene, and dipentene. It can be a homopolymer of one species of terpene or a copolymer of two or more species of terpene. Examples of a homopolymer of one species of terpene include α-pinene polymer, β-pinene polymer, and dipentene polymer.

Examples of a modified terpene resin include resins obtainable by modifying the terpene resins. Specific examples include styrene-modified terpene resins, hydrogenated terpene resins, etc. However, a species considered as a terpene phenol resin or a hydrogenated terpene phenol resin is treated as a phenolic resin instead of as a modified terpene resin.

Examples of a hydrocarbon-based tackifier resin include various hydrocarbon-based resins such as aliphatic hydrocarbon resins, aromatic hydrocarbon resins, alicyclic hydrocarbon resins, aliphatic/aromatic petroleum resins (styrene-olefin-based copolymer, etc.), aliphatic/alicyclic petroleum resins, hydrogenated hydrocarbon resins, coumarone-based resins, and coumarone-indene-based resins.

In a preferable embodiment, the tackifier resin comprises one, two or more species of phenolic tackifier resin (typically terpene phenol resin). The use of phenolic tackifier resin can improve the tightness of adhesion of the PSA layer to the adherend to effectively reduce grease penetration from the interface with the adherend. Phenolic tackifier resins tend to have lower lipophilicity as compared to, for instance, rosin-based tackifier resins. Thus, the phenolic tackifier resin content may contribute to reduction of grease penetration (oil absorption) into the PSA layer. Phenolic tackifier resins tend to have excellent blending properties in an embodiment using an acrylic polymer as the base polymer and have an advantage that it is likely to show desired adhesive properties.

The art disclosed herein can be preferably implemented in an embodiment where, for instance, a terpene phenol resin accounts for about 25% by weight or more (more preferably about 30% by weight or more) of the total tackifier resin content. Of the total tackifier resin content, the terpene phenol resin may account for about 50% by weight or more, or even about 80% by weight or more (e.g. about 90% by weight or more). The terpene phenol resin may account for essentially all (e.g. about 95% to 100% by weight, or even about 99% to 100% by weight) of the tackifier resin.

The amount of phenolic tackifier resin (e.g. terpene phenol resin) contained is not particularly limited. It is suitably about 5 parts by weight or greater to 100 parts by weight of the base polymer (preferably an acrylic polymer). From the standpoint of the adhesiveness and lipophilicity, it is preferably about 10 parts by weight or greater, more preferably about 15 parts by weight or greater, or yet more preferably about 20 parts by weight or greater (e.g. about 25 parts by weight or greater) to 100 parts by weight of the base polymer. The amount of phenolic tackifier resin (e.g. terpene phenol resin) contained is suitably about 80 parts by weight or less to 100 parts by weight of the base polymer. From the standpoint of the adhesive properties such as miscibility with the base polymer, adhesive strength and drop impact resistance, it is preferably less than 70 parts by weight, more preferably about 60 parts by weight or less, yet more preferably about 55 parts by weight or less, or particularly preferably about 45 parts by weight or less (e.g. about 40 parts by weight or less) to 100 parts by weight of the base polymer.

The PSA layer according to a preferable embodiment comprises a tackifier resin having a hydroxyl value of 120 mgKOH/g or greater (e.g. about 130 mgKOH/g or greater). The use of such a high-OH resin can improve the grease resistance while ensuring adhesive strength. The hydroxyl value of the high-OH resin is preferably about 140 mgKOH/g or greater, more preferably about 150 mgKOH/g or greater, yet more preferably about 170 mgKOH/g or greater, or particularly preferably about 190 mgKOH/g or greater (e.g. about 200 mgKOH/g or greater). The maximum hydroxyl value of the high-OH resin is not particularly limited. From the standpoint of the miscibility with the base polymer, etc., the hydroxyl value of the high-OH resin is usually suitably about 350 mgKOH/g or less, or preferably about 300 mgKOH/g or less (e.g. about 250 mgKOH/g or less).

Here, the hydroxyl value can be determined by the potentiometric titration method specified in JIS K0070:1992. Details of the method are described below.

### [Method for Measuring Hydroxyl Value]

### 1. Reagents

(1) As the acetylation reagent, is used a solution prepared by mixing with sufficient stirring about 12.5 g (approximately 11.8 mL) of anhydrous acetic acid and pyridine added up to a total volume of 50 mL. Alternatively, is used a solution prepared by mixing with sufficient stirring about 25 g (approximately 23.5 mL) of anhydrous acetic acid and pyridine up to a total volume of 100 mL.
(2) As the titrant, is used a 0.5 mol/L potassium hydroxide (KOH) solution in ethanol.
(3) For others, toluene, pyridine, ethanol and distilled water should be ready for use.

### 2. Procedures

(1) Approximately 2 g of analyte is accurately weighed out in a flat-bottom flask, 5 mL of the acetylation reagent and 10 mL of pyridine are added, and an air condenser is placed on.
(2) The flask is heated in a bath at 100° C. for 70 minutes and then cooled. From the top of the condenser, 35 mL of toluene is added as a solvent and stirred. Subsequently, 1 mL of distilled water is added and the resultant is stirred to decompose any remaining anhydrous acetic acid. The flask is heated in the bath again for 10 minutes to complete the decomposition and then cooled.
(3) After rinsed with 5 mL of ethanol, the condenser is removed. Subsequently, 50 mL of pyridine is added as a solvent and the resultant is stirred.
(4) Using a volumetric pipette, is added 25 mL of the 0.5 mol/L KOH ethanol solution.
(5) Potentiometric titration is carried out with the 0.5 mol/L KOH ethanol solution. The inflection point in the resulting titration curve is taken as the final point.
(6) For a blank titration, procedures (1) to (5) are carried out without addition of the analyte.

### 3. Calculations

The hydroxyl value is calculated by the following equation:

Hydroxyl value (mgKOH/g)=[(B−C)×f×28.05]/S+D

wherein:

B is the volume (mL) of the 0.5 mol/L KOH ethanol solution used in the blank titration;

C is the volume (mL) of the 0.5 mol/L KOH ethanol solution used to titrate the analyte;

f is the factor of the 0.5 mol/L KOH ethanol solution;

S is the weight of analyte (g);

D is the acid value;

28.05 is one half the molecular weight of KOH.

As the high-OH resin, a species having at least the prescribed hydroxyl value can be used among the various tackifier resins referred to above. For the high-OH resin, solely one species or a combination of two or more species can be used. For instance, as the high-OH resin, a phenolic tackifier resin having a hydroxyl value of 120 mgKOH/g or greater can be preferably used. In a preferable embodiment, as the tackifier resin, a terpene phenol resin having a hydroxyl value of 120 mgKOH/g or greater is used. The terpene phenol resin is convenient as the hydroxyl value can be arbitrarily controlled through the phenol's copolymerization ratio.

While no particular limitations are imposed, when using a high-OH resin, the ratio of the high-OH resin (e.g. a terpene phenol resin) in the total tackifier resin content of the PSA layer can be, for instance, about 25% by weight or higher, preferably about 30% by weight or higher, or more preferably about 50% by weight or higher (e.g. about 80% by weight or higher, typically about 90% by weight or higher). The high-OH resin may account for essentially all (e.g. about 95% to 100% by weight, or even about 99% to 100% by weight) of the tackifier resin. Thus, the PSA layer disclosed herein may include a non-high-OH tackifier resin (in particular, a tackifier resin having a hydroxyl value below 120 mgKOH/g) as long as the effect of this invention is not impaired.

The high-OH resin content is suitably about 5 parts by weight or greater (e.g. 10 parts by weight or greater) to 100 parts by weight of the base polymer (acrylic polymer). This may preferably bring about a PSA sheet that shows excellent grease resistance and tight adhesion to the adherend. From the standpoint of obtaining greater effect, the high-OH resin content relative to 100 parts by weight of the base polymer is preferably about 15 parts by weight or greater, more preferably about 20 parts by weight or greater, yet more preferably about 25 parts by weight or greater, or particularly preferably about 30 parts by weight or greater (e.g. about 35 parts by weight or greater). The maximum high-OH resin content is not particularly limited. From the standpoint of the miscibility with the base polymer, in an embodiment, it is usually suitably about 80 parts by weight or less to 100 parts by weight of the base polymer. From the standpoint of the adhesive properties such as adhesive strength and drop impact resistance, it is preferably less than 70 parts by weight, more preferably about 60 parts by weight or less, yet more preferably about 55 parts by weight or less, or particularly preferably about 50 parts by weight or less (e.g. about 45 parts by weight or less) to 100 parts by weight of the base polymer.

The softening point of the tackifier resin is not particularly limited. From the standpoint of increasing the cohesive strength, in an embodiment, it is preferable to use a tackifier resin having a softening point (softening temperature) of about 80° C. or above (preferably about 100° C. or above). The softening point is more preferably about 110° C. or above (e.g. about 120° C. or above). The art disclosed herein can be preferably implemented in an embodiment where the tackifier resin having such a softening point accounts for more than 50% by weight (more preferably more than 70% by weight, e.g. more than 90% by weight) of the total tackifier resin content of the PSA layer. For instance, a phenolic tackifier resin (a terpene phenol resin, etc.) having such a softening point can be preferably used. The maximum softening point of the tackifier resin is not particularly limited. From the standpoint of the tightness of adhesion to the adherend and substrate, in an embodiment, it is preferable to use a tackifier resin having a softening point of about 200° C. or below (more preferably about 180° C. or below). The softening point can be, for instance, about 150° C. or below, or even about 140° C. or below. The softening point of the tackifier resin can be determined based on the softening point test method (ring and ball method) specified in JIS K2207.

The tackifier resin content is not particularly limited. It is suitably about 5 parts by weight or greater (e.g. 10 parts by weight or greater) to 100 parts by weight of the base polymer (e.g. an acrylic polymer). This can favorably bring about the effect to increase the tightness of adhesion to the adherend. From the standpoint of obtaining higher tightness, the tackifier resin content relative to 100 parts by weight of the base polymer is preferably about 15 parts by weight or greater, more preferably about 20 parts by weight or greater, yet more preferably about 25 parts by weight or greater, or particularly preferably about 30 parts by weight or greater (e.g. about 35 parts by weight or greater). The maximum tackifier resin content is not particularly limited. From the standpoint of the miscibility with the base polymer and the initial adhesiveness, in an embodiment, it is usually suitably about 80 parts by weight or less to 100 parts by weight of the base polymer, preferably about 60 parts by weight or less, more preferably about 55 parts by weight or less, or yet more preferably about 50 parts by weight or less (e.g. about 45 parts by weight or less).

### (Crosslinking Agent)

The PSA composition used for forming PSA preferably comprises a crosslinking agent. By including the crosslinking agent in the PSA composition, a crosslinked structure is incorporated in the PSA. The type of crosslinking agent is not particularly limited. A suitable species can be selected and used among isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, amine-based crosslinking agents, and the like. For the crosslinking agent, solely one species or a combination of two or more species can be used. From the standpoint of the tightness of adhesion to the adherend and the drop impact resistance, an isocyanate-based crosslinking agent is preferable. From the standpoint of the ability to hold the adhesion state (including the layer shape), etc., an epoxy-based crosslinking agent is preferable. The art disclosed herein can provide a PSA sheet of higher performance while not using an epoxy-based crosslinking agent or using it in a smaller amount. For instance, an isocyanate-based crosslinking agent can be used as the primary crosslinking agent to enhance the resistance to grease penetration via the adhesive interface and combine grease resistance and drop impact resistance at a higher level.

As the epoxy-based crosslinking agent, a compound having at least two epoxy groups per molecule can be used without particular limitations. A preferable epoxy-based crosslinking agent has three to five epoxy groups per molecule. For the epoxy-based crosslinking agent, solely one species or a combination of two or more species can be used.

Specific examples of the epoxy-based crosslinking agent include, but are not particularly limited to, N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Commercial epoxy-based crosslinking agents include trade names TETRAD-C and TETRAD-X available from Mitsubishi Gas Chemical Co., Inc.; trade name EPICLOM CR-5L available from DIC Corporation; trade name DENACOL EX-512 available from Nagase ChemteX Corporation; and trade name TEPIC-G available from Nissan Chemical Industries, Ltd.

When an epoxy-based crosslinking agent is used, its amount is not particularly limited. For instance, it can be 3 parts by weight or less to 100 parts by weight of the base polymer (preferably an acrylic polymer). From the standpoint of increasing the adhesive strength and anchoring strength to adherends and substrates, the amount of epoxy-based crosslinking agent to 100 parts by weight of the base polymer is preferably 1 part by weight or less, or more preferably 0.5 part by weight or less (typically 0.2 part by weight or less, e.g. 0.1 part by weight or less, or even 0.05 part by weight or less). With decreasing amount of epoxy-based crosslinking agent used, the drop impact resistance tends to increase as well. From the standpoint of obtaining favorable effect to increase the cohesive strength, the amount of epoxy-based crosslinking agent to 100 parts by weight of the base polymer can be 0.001 part by weight or greater (e.g. 0.005 part by weight or greater).

As the isocyanate-based crosslinking agent, a polyfunctional isocyanate (which refers to a compound having an average of two or more isocyanate groups per molecule, including a compound having an isocyanurate structure) can be preferably used. For the isocyanate-based crosslinking agent, solely one species or a combination of two or more species can be used.

Examples of the polyfunctional isocyanate include aliphatic polyisocyanates, alicyclic polyisocyanates, and aromatic polyisocyanates.

Examples of an aliphatic polyisocyanate include 1,2-ethylene diisocyanate; tetramethylene diisocyanates such as 1,2-tetramethylene diisocyanate, 1,3-tetramethylene diisocyanate, 1,4-tetramethylene diisocyanate, etc.; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, etc.; 2-methyl-1,5-pentane diisocyanate, 3-methyl-1,5-pentane diisocyanate, and lysine diisocyanate.

Examples of an alicyclic polyisocyanate include isophorone diisocyanate; cyclohexyl diisocyanates such as 1,2-cyclohexyl diisocyanate, 1,3-cyclohexyl diisocyanate, 1,4-cyclohexyl diisocyanate, etc.; cyclopentyl diisocyanates such as 1,2-cyclopentyl diisocyanate, 1,3-cyclopentyl diisocyanate etc.; hydrogenated xylylene diisocyanate, hydrogenated tolylene diisocyanate, hydrogenated diphenylmethane diisocyanate, hydrogenated tetramethylxylene diisocyanate, and 4,4′-dicyclohexylmethane diisocyanate.

Examples of an aromatic polyisocyanate include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

A preferable example of the polyfunctional isocyanate has an average of three or more isocyanate groups per molecule. Such a tri-functional or higher polyfunctional isocyanate can be a multimer (typically a dimer or a trimer), a derivative (e.g., an addition product of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, and polyester polyisocyanate. Commercial polyfunctional isocyanates include trade name DURANATE TPA-100 available from Asahi Kasei Chemicals Corporation and trade names CORONATE L, CORONATE HL, CORONATE HK, CORONATE HX, and CORONATE 2096 available from Nippon Polyurethane Industry Co., Ltd.

When an isocyanate-based crosslinking agent is used, its amount is not particularly limited. For instance, to 100 parts by weight of the base polymer (preferably an acrylic polymer), it can be more than 0 part by weight up to about 10 parts by weight or less (typically 0.01 part to 10 parts by weight). From the standpoint of combining cohesive strength with tightness of adhesion or with resistance to grease penetration and of the drop impact resistance, etc., the amount of the isocyanate-based crosslinking agent to 100 parts by weight of the base polymer is preferably about 0.5 part by weight or greater, more preferably about 1 part by weight or greater, yet more preferably about 1.5 parts by weight or greater (e.g. about 2.5 parts by weight or greater, or even about 3.5 parts by weight or greater). From the same standpoint, the amount of the isocyanate-based crosslinking agent to 100 parts by weight of the base polymer is preferably about 8 parts by weight or less, more preferably about 6 parts by weight or less, yet more preferably about 5 parts by weight or less, or particularly preferably about 4 parts by weight or less.

The art disclosed herein is preferably implemented in an embodiment using epoxy-based and isocyanate-based crosslinking agents together. In such an embodiment, the relative amounts of epoxy-based and isocyanate-based crosslinking agents are not particularly limited. The amount of epoxy-based crosslinking agent can be, for instance, about 1/50 or less of the amount of isocyanate-based crosslinking agent. From the standpoint of favorably combining cohesive strength and tightness of adhesion to the adherend and substrate, the amount of epoxy-based crosslinking agent is suitably about 1/75 or less, or preferably about 1/100 or less (e.g. 1/150 or less) of the amount of isocyanate-based crosslinking agent. From the standpoint of favorably obtaining the effect of the combined use of epoxy-based and isocyanate-based crosslinking agents, the amount of epoxy-based crosslinking agent is usually suitably about 1/1000 or more, for instance, about 1/500 or more of the amount of isocyanate-based crosslinking agent.

The total amount of the crosslinking agent used is not particularly limited. For instance, to 100 parts by weight of the base polymer (preferably an acrylic polymer), it can be selected from a range of about 0.005 part by weight or greater (e.g. 0.01 part by weight or greater, typically 0.1 part by weight or greater) to about 10 parts by weight or less (e.g. about 8 parts by weight or less, preferably about 5 parts by weight or less).

### (Other Additives)

Besides the respective components described above, the PSA composition may comprise, as necessary, various additives generally used in the field of PSA, such as leveling agent, crosslinking co-agent, plasticizer, softening agent, anti-static agent, anti-aging agent, UV absorber, anti-oxidant, and photo-stabilizer. With respect to these various additives, heretofore known species can be used by typical methods. Because they do not particularly characterize this invention, details are omitted.

The PSA layer (a layer formed of the PSA) disclosed herein may be formed from an aqueous PSA composition, solvent-based PSA composition, hot-melt PSA composition, or active energy ray-curable PSA composition. The aqueous PSA composition refers to a PSA composition comprising a PSA (PSA layer-forming components) in a solvent primarily comprising water (an aqueous solvent) and typically encompasses what is called a water-dispersed PSA composition (a composition in which the PSA is at least partially dispersed in water). The solvent-based PSA composition refers to a PSA composition comprising a PSA in an organic solvent. From the standpoint of the adhesive properties and so on, the art disclosed herein can be preferably implemented in an embodiment having a PSA layer formed from a solvent-based PSA composition.

The PSA layer disclosed herein can be formed by a heretofore known method. For instance, in a possible method, the PSA composition is applied to a releasable surface (release face) or a non-releasable surface and allowed to dry to form a PSA layer. When the double-faced PSA sheet comprises a substrate, it is possible to employ a direct method where the PSA composition is directly provided (typically applied) to the substrate and allowed to dry to form a PSA layer. Alternatively, it is possible to employ a transfer method where the PSA composition is provided to a releasable surface (release face) and allowed to dry to form a PSA layer on the surface and the PSA layer is transferred to a substrate. From the standpoint of the productivity, the transfer method is preferable. As the release face, the surface of a release liner, a substrate's backside treated with a release agent, and like surface can be used. The PSA layer disclosed herein is not limited to, but typically formed in a continuous form. For instance, the PSA layer may be formed in a regular or random pattern of dots, stripes, etc.

The PSA composition can be applied with a heretofore known coater, for instance, a gravure roll coater, die coater, and bar coater. Alternatively, the PSA composition can be applied by immersion, curtain coating, etc.

From the standpoint of facilitating the crosslinking reaction, increasing the production efficiency, etc., the PSA composition is dried preferably with heating. The drying temperature can be, for instance, about 40° C. to 150° C.; it is usually preferably about 60° C. to 130° C. After the PSA composition is dried, it can be aged for purposes such as adjusting migration of the components in the PSA layer, accelerating the crosslinking reaction, and releasing the distortion that may be present in the PSA layer.

While no particular limitations are imposed, from the standpoint of the tightness of adhesion to the adherend and the resistance to grease penetration based on the tightness of adhesion, the Tg of the PSA layer forming the PSA sheet is preferably controlled at or below about 25° C. The PSA layer with such a Tg tends to have excellent drop impact resistance. The PSA layer's Tg is preferably about 20° C. or below (typically about 15° C. or below, e.g. 10° C. or below). From the standpoint of the ease of processing, etc., the PSA layer's Tg is suitably about −25° C. or above, preferably about −15° C. or above, more preferably about −10° C. or above (e.g. about −5° C. or above), or even about 0° C. or above (e.g. about 5° C. or above). According to the art disclosed herein, the PSA capable of exhibiting desired adhesive properties (e.g. adhesive strength and drop impact resistance) with such a Tg value can bring about improved grease resistance (typically reliable grease-resistant adhesion). In an embodiment where a tackifier resin species (typically a high-OH resin) is selected to increase the grease resistance, the Tg in these ranges can preferably bring about the effect to increase the grease resistance based on the viscoelastic properties of the PSA and the chemical properties of the tackifier resin. The PSA layer's Tg here refers to the glass transition temperature determined from the peak temperature of tan δ in dynamic viscoelastic measurement. The PSA layer's Tg can be adjusted through the PSA composition (e.g. base polymer's Tg, tackifier resin's softening point, species of crosslinking agent, their ratio) and the production method (polymerization conditions, etc.).

The tan δ peak (peak strength) of the PSA layer has a value of typically 1.0 or greater, preferably about 1.5 or greater, more preferably about 1.8 or greater, or yet more preferably about 2.0 or greater. With respect to the PSA having a tan δ peak in a relatively low temperature range (typically between −25° C. to 25° C.), when it has a peak strength of at least the prescribed values, it may have excellent drop impact resistance. The peak strength of tan δ is usually suitably about 3.0 or below, preferably about 2.5 or below, or even below about 2.2 (e.g. below 2.0). According to the art disclosed herein, the PSA capable of exhibiting desired adhesive properties (e.g. drop impact resistance) with such a tan δ peak strength can bring about improved grease resistance (typically reliability of grease-resistant adhesion). The tan δ peak strength of the PSA layer can be adjusted through the PSA composition (e.g. base polymer's Tg, tackifier resin's softening point, species of crosslinking agent, their ratio) and the production method (polymerization conditions, etc.).

The PSA layer disclosed herein is not particularly limited in storage modulus at 25° C. It can be, for instance, 1 MPa or less. The 25° C. storage modulus of the PSA layer can be about 0.5 MPa or less, or preferably about 0.3 MPa or less (e.g. about 0.25 MPa or less). With decreasing 25° C. storage modulus of the PSA layer, the flexibility of the PSA layer increases in a temperature range around room temperature, whereby the adhesive face can easily make tight contact with the adherend surface. This is beneficial in preventing grease penetration into the interface with the adherend. With the PSA having a storage modulus limited up to the prescribed values, good drop impact resistance is likely to be obtained. The 25° C. storage modulus can be about 0.01 MPa or greater. The PSA having a storage modulus of at least the prescribed value has suitable cohesion in a temperature range around room temperature; and therefore, the adhesive strength is easily increased. It can also be advantageous in view of facilitating processing the PSA sheet to have a narrow width, etc. From such a standpoint, the 25° C. storage modulus is suitably about 0.02 MPa or greater, preferably 0.05 MPa or greater, more preferably about 0.1 MPa or greater, yet more preferably about 0.14 MPa or greater, or particularly preferably about 0.18 MPa or greater (e.g. about 0.2 MPa or greater). According to the art disclosed herein, the PSA capable of exhibiting desired adhesive properties (e.g. adhesive strength and drop impact resistance) with such a 25° C. storage modulus can bring about improved grease resistance (typically reliable grease-resistant adhesion). The 25° C. storage modulus of the PSA layer can be adjusted through its composition, production method, etc.

The PSA layer disclosed herein is not particularly limited in loss modulus at 25° C. It can be, for instance, about 0.01 MPa or greater. The 25° C. loss modulus of the PSA layer is suitably about 0.02 MPa or greater, preferably about 0.05 MPa or greater, more preferably about 0.1 MPa or greater, yet more preferably about 0.15 MPa or greater, or particularly preferably about 0.17 MPa or greater (e.g. about 0.2 MPa or greater). The PSA exhibiting a 25° C. loss modulus of at least the prescribed values increases the tightness of adhesion to the adherend based on its viscosity factor (loss modulus). With increasing 25° C. loss modulus of the PSA layer, the drop impact resistance tends to increase as well. The 25° C. loss modulus of the PSA layer can be, for instance, about 1 MPa or less. From the standpoint of the cohesion and ease of processing, etc., the 25° C. loss modulus of the PSA layer can be about 0.5 MPa or less, or preferably about 0.3 MPa or less (e.g. about 0.25 MPa or less). According to the art disclosed herein, the PSA capable of exhibiting desired adhesive properties (e.g. adhesive strength and drop impact resistance) with such a 25° C. loss modulus can bring about improved grease resistance (typically reliable grease-resistant adhesion). The 25° C. loss modulus of the PSA layer can be adjusted through its composition, production method, etc.

The PSA layer's Tg (peak temperature of tan δ), peak strength at the peak tan δ (G″/G′), 25° C. storage modulus (G′(25° C.)) and 25° C. loss modulus (G″(25° C.)) can be obtained by dynamic viscoelasticity measurement. As for a specific measurement instrument, ARES available from TA Instruments or a comparable system can be used. Specific procedures and conditions of the measurement can be prescribed in accordance with the measurement conditions described later in Examples, or so as to obtain results comparable or corresponding to results obtained under the measurement conditions.

The PSA layer is not particularly limited in thickness. From the standpoint of avoiding too thick a PSA sheet, the PSA layer's thickness is usually suitably about 100 μm or less, preferably about 70 μm or less, more preferably about 60 μm or less, or yet more preferably about 50 μm or less. In general, with decreasing thickness of the PSA layer, the tightness of adhesion to the adherend tends to decrease, leading to increased likelihood of grease penetration via the interface with the adherend. Accordingly, it is particularly significant to apply the art disclosed herein to increase the grease resistance. The minimum thickness of the PSA layer is not particularly limited. From the standpoint of the tightness of adhesion to the adherend, it is advantageously about 3 μm or greater, preferably about 10 μm or greater, more preferably about 20 μm or greater (e.g. about 30 μm or greater). The PSA sheet disclosed herein may have a PSA layer having such a thickness on each face of a substrate. In a substrate-supported double-faced PSA sheet having the first and second PSA layers on the two faces of a substrate, respectively, the first and second PSA layer may have the same thickness or different thicknesses.

### <Substrate>

In applying the art disclosed herein to a substrate-supported double-faced PSA sheet, as the substrate (support substrate) to support (back) the PSA layer, a suitable species can be selected and used in accordance with the purpose of the PSA sheet among plastic films such as polyolefin films comprising a polyolefin as the primary component including polypropylenes and ethylene-propylene copolymers, polyester films comprising a polyester as the primary component including polyethylene terephthalate (PET) and polybutylene terephthalate, polyvinyl chloride films comprising polyvinyl chloride as the primary component; foam sheets made of foam such as polyurethane foam, polyethylene foam, and polychloroprene foam; woven fabrics and non-woven fabrics (meaning to include paper such as Washi and high-grade paper) of a single species or a blend of various species of fibrous substances (which can be natural fibers such as hemp and cotton; synthetic fibers such as polyester and vinylon; semi-synthetic fibers such as acetate); metal foil such as aluminum foil and copper foil. The substrate supporting the PSA layer may be referred to as a substrate layer in the PSA sheet.

### (Foam Substrate)

In a preferable embodiment, the double-faced PSA sheet comprises a foam substrate. In particular, the PSA sheet is formed as a double-faced PSA sheet having a PSA layer on each face of the foam substrate. In the art disclosed herein, the foam substrate refers to a substrate that includes a portion having pores (a porous structure), typically a substrate that includes at least one layer of foam (a foam layer). The foam substrate may be formed of one, two or more foam layers. For instance, the foam substrate may essentially consist of one, two or more foam layers. While no particular limitations are imposed, a favorable example of the foam substrate in the art disclosed herein is a foam substrate formed of a single foam layer. With the use of the foam substrate, superior grease resistance is obtained as compared to an embodiment using no substrate or using a resin film substrate. Non-limiting possible factors for this may include the increased tightness of adhesion at the interface with the adherend due to the use of the foam substrate, the sealing properties of the foam substrate itself and reduction of grease penetration into the adhesive interface in the bulk.

The foam substrate is not particularly limited in density D (apparent density; the same applies hereinafter unless otherwise noted). It can be, for instance, about 0.1 g/cm³ to 0.9 g/cm³. From the standpoint of grease absorption to reduce the amount of grease penetrating the adhesive interface, the density D of the foam substrate is suitably about 0.8 g/cm³ or less, or preferably about 0.7 g/cm³ or less (e.g. about 0.6 g/cm³ or less). In an embodiment, the density D of the foam substrate can be 0.5 g/cm³ or less or even less than 0.5 g/cm³ (e.g. less than 0.4 g/cm³). From the standpoint of increasing the grease resistance based on the sealing properties of the foam substrate itself, the density D of the foam substrate is preferably about 0.12 g/cm³ or greater, more preferably about 0.15 g/cm³ or greater, or yet more preferably 0.2 g/cm³ or greater (e.g. about 0.3 g/cm³ or greater). In an embodiment, the density D of the foam substrate can be about 0.4 g/cm³ or greater, about 0.5 g/cm³ or greater (e.g. greater than 0.5 g/cm³), or even 0.55 g/cm³ or greater. The foam substrate having a density in these ranges tends to have excellent drop impact resistance. The density D (apparent density) of the foam substrate can be determined based on JIS K 6767.

The mean pore diameter of the foam substrate is not particularly limited. From the standpoint of inhibiting degradation of properties with the narrowing of the width, it is preferably about 300 μm or less, more preferably about 200 μm or less, or yet more preferably about 150 μm or less. From the standpoint of obtaining higher levels of grease resistance, waterproofness and dust resistance, the mean pore diameter of the foam substrate is preferably about 120 μm or less, or more preferably about 100 μm or less (typically about 90 μm or less, e.g. about 80 μm or less, or even about 70 μm or less). The minimum mean pore diameter is not particularly limited. From the standpoint of grease absorption to reduce the amount of grease penetrating the adhesive interface, it is usually suitably about 10 μm or greater, preferably about 20 μm or greater, more preferably about 30 μm or greater, or yet more preferably about 40 μm or greater (e.g. about 50 μm or greater). In an embodiment, the mean pore diameter can be 55 μm or greater, or even 60 μm or greater. With increasing mean pore diameter, the drop impact resistance tends to increase as well. The mean pore diameter here refers to the mean pore diameter of the corresponding perfect sphere, obtained by analyzing a cross section of the foam substrate by electron microscopy.

Pores in the foam substrate preferably have relatively near-circle shapes in planar view of the foam substrate. In other words, it is preferable that the mean pore diameter in the machine direction (or MD hereinafter) is not excessively different from the mean pore diameter in the cross direction (or CD hereinafter). The extent of deviation of the pores from circles can be obtained as an “aspect ratio (MD/CD)” represented by the equation shown below, which is the ratio of the mean pore diameter in MD (mean MD pore diameter) to the mean pore diameter in CD (mean CD pore diameter) of the foam substrate. The closer to 1 the aspect ratio (MD/CD) is, the closer to circles the shapes of pores in the foam substrate are in planar view.

Aspect ratio (MD/CD)=mean MD pore diameter/mean CD pore diameter

In an embodiment of the art disclosed herein, pores in the foam substrate has an aspect ratio (MD/CD) of preferably 0.7 or higher, more preferably 0.75 or higher, or yet more preferably 0.8 or higher, for instance, possibly 0.85 or higher. In an embodiment, the aspect ratio can be 0.9 or higher, or even 0.95 or higher (e.g. about 1.0 or higher). The aspect ratio (MD/CD) is preferably 1.3 or lower, more preferably 1.25 or lower, or yet more preferably 1.2 or lower, for instance, 1.15 or lower. When the aspect ratio (MD/CD) is not too far below 1, the handling properties of the PSA sheet using the foam substrate may improve. When the aspect ratio (MD/CD) is not too far above 1, the grease resistance, waterproofness and dust resistance of the PSA sheet using the foam substrate may increase. It is particularly beneficial to have an aspect ratio (MD/CD) near 1 in a foam substrate that forms a PSA sheet used in an embodiment having a narrow segment (especially in an embodiment of a frame-shaped member having a narrow segment) as described later.

Here, the foam substrate's MD refers to the direction of extrusion in the process of producing the foam substrate. While no particular limitations are imposed, MD usually coincides with the length direction in a foam substrate having a long form like a tape form. The foam substrate's CD refers to the direction that is vertical to its MD and in parallel with its surface. The thickness direction (or VD hereinafter) of the foam substrate is vertical to both MD and CD.

The mean MD pore diameter of the foam substrate is determined as follows. In particular, the foam substrate is cut in a plane containing MD and VD (in a plane whose perpendicular line is in CD) approximately at the center of CD (at the center of the width) and an image is taken of the central part of the resulting cross section by scanning electron microscopy (SEM). The image is printed on A4-size paper and a 60 mm long straight line is drawn in MD on the image. For this, the magnification rate of SEM is adjusted so that 10 to 20 pores are present on the 60 mm long straight line. The number of pores present on the line is visually counted and the mean MD pore diameter is determined by the next equation:

Mean MD pore diameter (μm)=60 (mm)×10³/(number of pores×magnification rate)

The mean CD pore diameter of the foam substrate is determined as follows. In particular, the foam substrate is cut in a plane containing CD and VD (in a plane whose perpendicular line is in MD) approximately and an image is taken of the central part of the resulting cross section by SEM. The image is printed on A4-size paper and a 60 mm long straight line is drawn in CD on the image. For this, the magnification rate of SEM is adjusted so that 10 to 20 pores are present on the 60 mm long straight line. The number of pores present on the line is visually counted and the mean CD pore diameter is determined by the next equation:

Mean CD pore diameter (μm)=60 (mm)×10³/(number of pores×magnification rate)

The straight line shall be drawn, running through as many pores as possible instead of making point contact. When a pore is in point contact with the line, this pore is counted as one. When the line runs into, but not through a pore at an end, this pore is counted as a half (0.5).

The foam substrate's mean pore diameter in each direction can be controlled, for instance, by adjusting the foam substrate's composition (the amount of foaming agent, etc.) and production conditions (conditions of the foaming step, stretching step, etc.).

A preferable foam substrate in the art disclosed herein has a 10% compressive strength C₁₀ (kPa) and a 30% compressive strength C₃₀ (kPa), satisfying the next relationship C₃₀/C₁₀≤5.0. Here, the 10% compressive strength of the foam substrate refers to the load at 10% compression, which is the load required to compress a measurement sample of the foam substrate by a thickness equivalent to 10% of the initial thickness, wherein the measurement sample is prepared by layering 30 mm square pieces of the foam substrate to a thickness of about 2 mm. In other words, it refers to the load required to compress the measurement sample to a thickness equivalent to 90% of the initial thickness. Similarly, the 30% compressive strength C₃₀ (kPa) and 25% compressive strength C₂₅ (kPa) described later refer to the loads required to compress the measurement sample by thicknesses equivalent to 30% and 25% of the initial thickness, respectively.

The foam substrate's compressive strength at an arbitrary compression rate is determined based on JIS K 6767. In specific procedures, the measurement sample is set at the center of the pair of flat plates, the flat plates are moved to narrow the inter-plate distance and continuously compress the sample to the prescribed compression rate and stopped (held) there, and the load is measured at 10 seconds after the flat plates are stopped. The foam substrate's compressive strength can be controlled, for instance, through the degree of crosslinking and density of the material forming the foam substrate as well as sizes and shapes of pores, etc.

A small compressive strength ratio (C₃₀/C₁₀) indicates that the difference in level of compression has minor impact on the compressive strength. Some portion of the PSA sheet may be compressed more than the rest (the PSA sheet may be compressed unevenly), for instance, in cases where the bonding surface of the PSA sheet includes unevenness such as bumps and scratches, where the PSA sheet partially varies in width, where the joint formed with some portion of the PSA sheet is subjected to larger stress than the rest (the PSA sheet is subjected to uneven stress) and so on. When the PSA sheet has a narrow width, factors such as the bumps and partial variation in width tend to cause more notable differences in level of compression. When the difference in compressive strength is excessively large due to a difference in level of compression, deformation may be localized to where the level of compression changes, initiating the occurrence of peeling of the PSA sheet or damage to the foam substrate in this location. The PSA sheet using a foam substrate having a small C₃₀/C₁₀ ratio value has a small difference in compressive strength caused by the difference in level of compression; and therefore, the peeling and damage to the foam substrate are less likely to occur. This may be advantageous from the standpoint of increasing the drop impact resistance. From the standpoint of obtaining greater effect, the C₃₀/C₁₀ ratio is preferably 4.5 or lower, yet more preferably 4.0 or lower, or possibly 3.5 or lower. The minimum C₃₀/C₁₀ value is not particularly limited. It is suitably, for instance, 2.5 or higher, or possibly 3.0 or higher.

The 25% compressive strength C₂₅ of the foam substrate is not particularly limited. It can be, for instance, 20 kPa or greater (typically 40 kPa or greater). C₂₅ is usually suitably 250 kPa or greater, or preferably 300 kPa or greater (e.g. 400 kPa or greater). The PSA sheet having such a foam substrate may exhibit good durability against impact such as dropping even when it has a narrow width. For instance, the PSA sheet may show greater resistance to impact-induced tearing. The maximum C₂₅ value is not particularly limited. It is usually suitably 1300 kPa or less (e.g. 1200 kPa or less). In an embodiment, C₂₅ can be 1000 kPa or less, 800 kPa or less, or even 600 kPa or less (e.g. 500 kPa or less). Greater results can be obtained with the PSA sheet having a foam substrate whose C₂₅ (kPa) and apparent density D (g/cm³) satisfy the next relationship: 150≤C₂₅*D≤400 (e.g. 200≤C₂₅*D≤350, preferably 240≤C₂₅*D≤300).

In another preferable embodiment, the foam substrate can have a C₂₅ of 20 kPa to 200 kPa (typically 30 kPa to 150 kPa, e.g. 40 kPa to 120 kPa). The PSA sheet having such a foam substrate has relatively low compressive strength for its density. Thus, it may have excellent cushioning properties even when it has a narrow width. For instance, the foam substrate may absorb drop impact to better prevent the PSA sheet from peeling. Greater results can be obtained with the PSA sheet having a foam substrate whose C₂₅ (kPa) and apparent density D (g/cm³) satisfy the next relationship: 100≤C₂₅/D≤400 (e.g. 150≤C₂₅/D≤350, preferably 200≤C₂₅/D≤300).

The foam substrate is not particularly limited in tensile elongation. For instance, a favorable foam substrate has an MD (machine direction) tensile elongation of 200% to 800% (more preferably 400% to 600 V. A preferable foam substrate has a TD (transverse direction) tensile elongation of 50% to 800% (more preferably 200% to 500 V. The tensile elongation of a foam substrate is measured based on JIS K 6767. The elongation of the foam substrate can be controlled, for instance, by the degree of crosslinking, apparent density (expansion ratio), etc.

The foam substrate is not particularly limited in tensile strength. For instance, a favorable foam substrate has a MD tensile strength of 5 MPa to 35 MPa (preferably 10 MPa to 30 MPa). Another preferable foam substrate has a TD tensile strength of 1 MPa to 25 MPa (more preferably 5 MPa to 20 MPa). The tensile strength of the foam substrate is determined based on JIS K6767. The tensile strength of the foam substrate can be controlled, for instance, by the degree of crosslinking, apparent density (expansion ratio), etc.

The material of the foam substrate is not particularly limited. It is usually preferable to use a foam substrate comprising a layer formed of plastic foam (foam of a plastic material). The plastic material (meaning to encompass rubber materials) for forming the plastic foam is not particularly limited, and can be suitably selected among known plastic materials. One species of plastic material can be used solely, or two or more species can be used in combination.

Specific examples of a plastic foam include polyolefin-based resin foams such as polyethylene foams, and polypropylene foams; polyester-based resin foams such as PET foams, polyethylene naphthalate foams, and polybutylene terephthalate foams; polyvinyl chloride-based resin foams such as polyvinyl chloride foams; vinyl acetate-based resin foams; polyphenylene sulfide resin foams; amide-based resin foams such as polyamide (nylon) resin foams, and wholly aromatic polyamide (aramid) resin foams; polyimide-based resin foams; polyether ether ketone (PEEK) resin foams; styrene-based resin foams such as polystyrene foams; urethane-based resin foams such as polyurethane resin foams; and the like. Alternatively, as the plastic foam, a rubber-based resin foam can be used, such as polychloroprene rubber foam.

Examples of preferable foam include polyolefin-based resin foams (or polyolefin-based foams, hereinafter). The polyolefinic foam substrate is highly lipophilic and can hold grease well; and therefore, it can effectively reduce penetration of grease into the adhesive interface. As the polyolefin-based resin foam-constituting plastic material (i.e., a polyolefin-based resin), can be used a known or conventional polyolefin-based resin of various types without any particular limitations. Examples include polyethylenes such as low density polyethylenes (LDPE), linear low density polyethylenes (LLDPE), and high density polyethylenes (HDPE); polypropylenes; ethylene-propylene copolymers; ethylene-vinyl acetate copolymers; and the like. Examples of LLDPE include Ziegler-Natta catalyst-based linear low density polyethylenes and metallocene-catalyst-based linear low density polyethylenes. Among these polyolefin-based resins, can be used one species alone, or two or more species in a suitable combination.

From the standpoint of the grease-absorbing properties, waterproofness, dust resistance, drop impact resistance, etc., particularly preferable examples of the foam substrate in the art disclosed herein include polyolefinic foam substrates such as a polyethylene-based foam substrate consisting essentially of a polyethylene-based resin foam, a polypropylene-based foam substrate consisting essentially of a polypropylene-based resin foam, and the like. Here, the polyethylene-based resin refers to a resin formed from ethylene as the primary monomer (i.e., the primary component among monomers), with the resin encompassing HDPE, LDPE and LLDPE as well as ethylene-propylene copolymers and ethylene-vinyl acetate copolymers each having a copolymerization ratio of ethylene exceeding 50% by weight, and the like. Similarly, the polypropylene-based resin refers to a resin formed from propylene as the primary monomer. As the foam substrate in the art disclosed herein, can be preferably used a polyethylene-based foam substrate.

The method for producing the plastic foam (typically polyolefinic foam) is not particularly limited. Various known methods can be suitably employed. For instance, it can be produced by a method that comprises a molding step, a crosslinking step and a foaming step of the plastic foam. It may also include a stretching step as necessary.

Examples of the method for crosslinking the plastic foam include a chemical crosslinking method that uses an organic peroxide, etc.; and a crosslinking method involving ionizing radiation (ionizing radiation crosslinking) These methods can be used in combination. Examples of the ionizing radiation include electron beam, α radiation, β radiation and γ radiation. The dosage of the ionizing radiation is not particularly limited. A suitable dosage can be selected according to physical properties (e.g. the degree of crosslinking) desired for the foam substrate, etc.

The foam substrate may comprise various additives as necessary such as fillers (inorganic fillers, organic fillers, etc.), anti-aging agent, antioxidant, UV absorber, anti-static agent, slipping agent, plasticizers, flame retardant, and surfactant.

The foam substrate in the art disclosed herein may be colored in order to bring about desirable design or optical properties (e.g., light-blocking ability, light-reflecting ability, etc.) in the PSA sheet. For coloring the foam substrate, among known organic or inorganic colorants, solely one species or a combination of two or more species can be used.

For example, when the PSA sheet disclosed herein is used for a light blocking purpose, although not particularly limited, the foam substrate has a visible light transmittance of preferably 0% to 15%, or more preferably 0% to 10% or lower, similarly to the visible light transmittance of the PSA sheet described later. When the PSA sheet disclosed herein is used for a light reflecting purpose, the foam substrate has a visible light reflectivity of preferably 20% to 100% or lower, or more preferably 25% to 100% or lower, similarly to the visible light reflectivity of the PSA sheet.

The visible light transmittance of a foam substrate can be determined by irradiating one face of the foam substrate with 550 nm wavelength light using a spectrophotometer (e.g., a spectrophotometer under model number U-4100 available from Hitachi High-Technologies Corporation) and measuring the intensity of the light transmitted to the other side of the foam substrate. The visible light reflectivity of a foam substrate can be determined by irradiating one face of the foam substrate with 550 nm wavelength light using the spectrophotometer and measuring the intensity of the light reflected by the foam substrate. The visible light transmittance and the visible light reflectivity of a PSA sheet can be determined by the same methods as well.

When the PSA sheet disclosed herein is used to block light, the foam substrate is preferably colored black. The black color has a lightness (L*) as specified by the L*a*b* color space of preferably 35 or lower (e.g., 0 to 35), or more preferably 30 or lower (e.g., 0 to 30). The values of a* and b* as specified by the L*a*b* color space can be suitably selected according to the value of L*. Neither a* nor b* is particularly limited, but it is preferable that each value is in a range of −10 to 10 (more preferably −5 to 5, or even more preferably −2.5 to 2.5). For example, it is preferable that each of a* and b* is zero or near zero.

In the present description, the values of L*, a* and b* as specified by the L*a*b* color space can be determined through measurements with a colorimeter (e.g., colorimeter CR-200 available from Konica Minolta Holdings Inc.). The L*a*b* color space refers to the CIE 1976 (L*a*b*) color space defined by the International Commission on Illumination (CIE) in 1976. In Japanese Industrial Standards, the L*a*b* color space is specified in JIS Z 8729.

Examples of black colorant for coloring the foam substrate black include carbon blacks (furnace black, channel black, acetylene black, thermal black, lamp black, etc.), graphite, copper oxide, manganese(IV) oxide, aniline black, perylene black, titanium black, cyanine black, activated carbon, ferrites (non-magnetic ferrite, magnetic ferrite, etc.), magnetite, chromium oxide, iron oxide, molybdenum disulfide, chromium complexes, composite-oxide-based black colorants, anthraquinone-based organic black colorants, and the like. From the standpoint of the cost and the availability, for example, carbon blacks are preferable as the black colorant. The amount of black colorant is not particularly limited, and they can be used in an amount suitable for producing desirable optical properties.

When the PSA sheet is used for a light reflecting purpose, it is preferable that the foam substrate is colored white. The white color has a lightness (L*) of preferably 87 or higher (e.g., 87 to 100), or more preferably 90 or higher (e.g., 90 to 100). The values of a* and b* as specified by the L*a*b* color space can be suitably selected according to the value of L*. It is preferable that each of a* and b* is in a range of −10 to 10 (more preferably −5 to 5, or even more preferably −2.5 to 2.5). For example, it is preferable that each of a* and b* is zero or near zero.

Examples of a white colorant include inorganic white colorants such as titanium oxides (e.g., titanium dioxides such as rutile titanium dioxide, anatase titanium dioxide, etc.), zinc oxide, aluminum oxide, silicon oxide, zirconium oxide, magnesium oxide, calcium oxide, tin oxide, barium oxide, cesium oxide, yttrium oxide, magnesium carbonate, calcium carbonates (light calcium carbonate, heavy calcium carbonate, etc.), barium carbonate, zinc carbonate, aluminum hydroxide, calcium hydroxide, magnesium hydroxide, zinc hydroxide, aluminum silicate, magnesium silicate, calcium silicate, barium sulfate, calcium sulfate, barium stearate, zinc oxide, zinc sulfide, talc, silica, alumina, clay, kaolin, titanium phosphate, mica, gypsum, white carbon, diatomaceous earth, bentonite, lithopone, zeolite, sericite, hydrated halloysite, etc.; organic white colorants such as acrylic resin particles, polystyrene-based resin particles, polyurethane-based resin particles, amide-based resin particles, polycarbonate-based resin particles, silicone-based resin particles, urea-formaldehyde-based resin particles, melamine resin particles, etc.; and the like. The amount of white colorant is not particularly limited, and they can be used in an amount suitable for producing desirable optical properties.

The surface of the foam substrate can be subjected as necessary to suitable surface treatment. The surface treatment may be, for instance, a chemical or physical treatment to increase the tightness of contact with the adjacent material (e.g. a PSA layer). Examples of the surface treatment include corona discharge treatment, chromic acid treatment, ozone exposure, flame exposure, UV irradiation, plasma treatment, and undercoat (primer) application.

The thickness of the foam substrate is not particularly limited. It can be suitably selected in accordance with the strength and flexibility of the double-faced PSA sheet and its purpose of use. From the standpoint of thinning the joint, the thickness of the foam substrate is usually suitably about 0.70 mm or less, preferably about 0.40 mm or less, or more preferably about 0.30 mm or less. From the standpoint of the ease of processing the PSA sheet to have a narrow width, the art disclosed herein can be preferably implemented in an embodiment where the thickness of the foam substrate is about 0.20 mm or less (typically 0.18 mm or less, e.g. 0.16 mm or less). From the standpoint of reducing the amount of grease penetrating the adhesive interface, etc., the thickness of the foam substrate is suitably about 0.05 mm or greater, preferably about 0.06 mm or greater, or more preferably about 0.07 mm or greater (e.g. about 0.08 mm or greater). The art disclosed herein can be preferably implemented in an embodiment where the foam substrate has a thickness of about 0.10 mm or greater (typically greater than 0.10 mm, preferably 0.12 mm or greater, e.g. 0.13 mm or greater). With increasing thickness of the foam substrate, the drop impact resistance improves as well, whereby desirable drop impact resistance tends to be obtained even in an embodiment having a narrower width.

The PSA sheet according to another embodiment may have a substrate film layer. In the PSA sheet in the embodiment including a substrate film layer, it is preferable to use a substrate film layer that includes a resin film layer as the base film layer. The base film layer is typically a member that can retain its shape by itself (self-standing). The substrate film layer in the art disclosed herein may be formed essentially of such a base film layer. Alternatively, the substrate film layer may include a supplementary layer in addition to the base film layer. Examples of the supplementary layer include a primer layer, an antistatic layer and a colored layer provided to the surface of the base film layer.

The resin film comprises a resin material as the primary component (a component accounting for more than 50% by weight of the resin film) Examples of the resin film include polyolefinic resin films such as polyethylene (PE), polypropylene (PP), and ethylene-propylene copolymer; polyester-based resin films such as polyethylene terephthalate (PET), polybutylene terephthalate (PBT), and polyethylene naphthalate (PEN); vinyl chloride-based resin film; vinyl acetate-based resin film; polyimide-based resin film; polyamide-based resin film; fluororesin film; and cellophane. The resin film can also be a rubber-based film such as natural rubber film and butyl rubber film. In particular, from the standpoint of the handling properties and the ease of processing, polyester films are preferable and among them PET film is particularly preferable. As used herein, the “resin film” typically refers to a non-porous sheet and should be conceptually distinguished from so-called non-woven and woven fabrics (i.e. the concept excludes non-woven and woven fabrics).

To the resin film (e g PET film), various additives can be added as necessary, such as fillers (inorganic and organic fillers, etc.), colorant, dispersing agent (surfactant, etc.), anti-aging agent, antioxidant, UV absorber, anti-static agent, slip agent and plasticizer. The total amount of various additives is usually less than about 30% by weight (e.g. less than about 20% by weight, typically less than about 10% by weight).

The resin film may have a monolayer structure or a multilayer structure with two, three or more layers. From the standpoint of the shape stability, the resin film preferably has a monolayer structure. In case of a multilayer structure, at least one layer (preferably each layer) preferably has a continuous structure formed of the resin (e.g. a polyester-based resin). The method for producing the resin film is not particularly limited and a heretofore known method can be suitably employed. For instance, heretofore known general film-forming methods can be suitably employed, such as extrusion, inflation molding, T-die casting, and calender rolling.

In the PSA sheet in an embodiment including a substrate film layer, the thickness of the substrate film layer is not particularly limited. From the standpoint of avoiding too thick a PSA sheet, the thickness of the substrate film can be, for instance, about 200 μm or less, preferably about 150 μm or less, or more preferably about 100 μm or less. According to the purpose and application of the PSA sheet, the substrate film layer can have a thickness of about 70 μm or less, about 50 μm or less, or even about 30 μm or less (e.g. about 25 μm or less). In an embodiment, the thickness of the substrate film layer can be about 20 μm or less, about 15 μm or less, or even about 10 μm or less (e.g. about 5 μm or less). When the substrate film layer has a small thickness, the PSA layer can be made thicker even when the overall thickness of the PSA sheet is kept the same. This may be advantageous in view of increasing the tightness of adhesion to the substrate. The minimum thickness of the substrate film layer is not particularly limited. From the standpoint of the PSA sheet's handling properties and ease of processing, etc., the thickness of the substrate film layer is usually about 0.5 μm or greater (e.g. 1 μm or greater), or preferably about 2 μm or greater, for instance, about 4 μm or greater. In an embodiment, the thickness of the substrate film layer can be about 6 μm or greater, about 8 μm or greater, or even about 10 μm or greater (e.g. greater than 10 μm).

The surface (typically the PSA layer-side surface) of the substrate (e.g. a substrate film layer) can be subjected to heretofore known surface treatment such as corona discharge treatment, plasma treatment, UV irradiation, acid treatment, base treatment and undercoating. Such surface treatment may increase the tightness of adhesion between the substrate film layer and the PSA layer, that is, the anchoring of the PSA layer to the substrate film.

The thickness of the substrate can be suitably selected in accordance with the purpose. It is generally about 2 μm or greater (e.g. 10μm or greater, typically 20 μm or greater) and about 1000 μm or less (e.g. 500 μm or less, typically 200 μm or less).

### <Release Liner>

In the art disclosed herein, a release liner can be used in forming the PSA layer, fabricating the PSA sheet, and storing, distributing and shaping the PSA sheet before used, etc. The release liner is not particularly limited. Examples include a release liner having a release layer on a face of a release liner substrate such as resin film and paper as well as a release liner formed of a low-adhesive material such as fluoropolymer (polytetrafluoroethylene, etc.) and polyolefinic resin (polyethylene, polypropylene, etc.). The release layer may be formed by subjecting the liner substrate to surface treatment with a release agent such as silicone-based, long-chain alkyl and fluorine-based kinds, and molybdenum sulfide.

### <Overall Thickness of PSA Sheet>

The PSA sheet disclosed herein is not particularly limited in thickness (including the PSA layer and possibly the substrate layer if any, but excluding the release liner if any). The overall thickness of the PSA sheet can be, for instance, about 800 μm or less. From the standpoint of making thinner portable devices, it is usually suitably about 500 μm or less, or preferably about 350 μm or less (e.g. about 300 μm or less). The art disclosed herein can be implemented in an embodiment of a PSA sheet (typically a double-faced PSA sheet) having an overall thickness of about 150 μm or less (more preferably about 100 μm or less, or yet more preferably less than about 60 μm, e.g. about 50 μm or less). The minimum thickness of the PSA sheet is not particularly limited. It is usually suitably about 10 μm or greater, preferably about 20 μm or greater, or more preferably about 30 μm or greater. In the PSA sheet having a foam substrate, the PSA sheet usually has a thickness of suitably about 60 μm or greater, preferably about 100 μm or greater, more preferably about 150 μm or greater, yet more preferably about 180 μm or greater, or particularly preferably about 200 μm or greater (e.g. about 220 μm or greater).

### <Applications>

The PSA sheet disclosed herein provides reliable adhesion even when touched with grease. For this feature, the PSA sheet can be preferably used for fastening components in various portable devices. For instance, it is favorable for fixing components (including various wires) of portable electronics. Non-limiting examples of portable electronics include smartphones, tablet PCs, notebook PCs, various wearable devices (e.g. wrist wears put on wrists such as wrist watches; modular devices attached to bodies with a clip, strap, etc.; eye wears including glass-shaped wears (monoscopic or stereoscopic, including head-mounted pieces); clothing types worn as, for instance, accessories on shirts, socks, hats/caps, etc.; ear wears such as earphones put on ears; etc.), digital cameras, digital video cameras, acoustic equipment (portable music players, IC recorders, etc.), calculators (e.g. pocket calculators), handheld game devices, electronic dictionaries, electronic notebooks, electronic books, vehicle navigation devices, portable radios, portable TVs, portable printers, portable scanners, and portable modems. Non-limiting examples of portable devices other than portable electronics include mechanical watch, pocket watch, pocket light, handheld mirror and pass case. As used herein, being “portable” means not just providing simple mobility, but further providing a level of portability that allows relatively easy carry by an individual (average adult).

The PSA sheet according to a particularly preferable embodiment is used for bonding and fixing components of portable electronics having touch panels. These portable electronics have display/input members (typically touch panels) serving as both displays (outputs) and input devices and surfaces of the display/input members are directly touched by user's fingertips for operation; and they are susceptible to accumulation of grease from foods, the skin secretion such as sebum and hand oils, and chemicals such as cosmetics, hair styling products, moisturizing cream, and sunscreens. With respect to such portable electronics that are often exposed to grease, the grease resistance of the PSA sheet disclosed herein may work preferably.

The PSA sheet (typically a double-faced PSA sheet) disclosed herein can be processed into various shapes and used as a joint for fixing components of portable electronics. Particularly preferable applications include fixing components of portable electronics. In particular, it can be preferably used in portable electronics having liquid crystal displays (LCD). For instance, in such a portable electronic device, it is favorable to bond a case and a display (possibly a display of LCD) or a protective material for the display.

In a preferable embodiment, the joint has a narrow segment having a width of 4.0 mm or less (e.g. 2.0 mm or less, typically less than 2.0 mm) The PSA sheet disclosed herein can fasten components well even when used as a joint having a shape (e.g. a frame shape) that includes such a narrow segment. In an embodiment, the narrow segment may have a width of 1.5 mm or less, 1.0 mm or less, or even about 0.5 mm or less. The minimum width of the narrow segment is not particularly limited. From the standpoint of the handling properties of the PSA sheet, it is usually suitably 0.1 mm or greater (typically 0.2 mm or greater).

The narrow segment is typically linear. Here, the concept of being linear encompasses shapes that are straight, curved, bent (e.g. L-shaped) and also ring-shaped (frame-shaped, circular, etc.) as well as their composite or intermediate shapes. The ring shape is not limited to a curved shape. The concept encompasses, for instance, a ring shape of which part or all is straight, such as a shape that conforms to the circumference of a square (i.e. a frame shape) and a shape that conforms to a sector shape. The narrow segment is not particularly limited in length. For instance, in an embodiment where the narrow segment has a length of 10 mm or greater (typically 20 mm or greater, e.g. 30 mm or greater), the effect of the art disclosed herein can be favorably obtained.

Matters disclosed by the present description include the following:

(1) A portable electronic device having a touch panel whose display also serves as an input device, wherein

the touch panel can be operated by direct finger touch,

the portable electronic device has components bonded with a PSA sheet

the PSA sheet is an adhesively double-faced PSA sheet having a PSA layer,

the PSA sheet has an initial push-peel strength of 0.5 MPa or greater,

the PSA sheet has a push-peel strength at 24 hours after artificial sebum application, retaining at least 25% of the initial push-peel strength (the PSA sheet has an adhesive strength retention rate of 25% or higher, determined as the ratio of the push-peel strength at 24 hours after artificial sebum application to the push-peel strength before the artificial sebum application).

(2) The portable electronic device according to (1) above, that is a portable phone.
(3) The portable electronic device according to (1) above, that is a smartphone.
(4) The portable electronic device according to (1) above, that is a tablet PC.
(5) The portable electronic device according to (1) above, that is a wearable device.
(6) The portable electronic device according to (1) above, that is a digital camera.
(7) The portable electronic device according to (1) above, that is a portable music player.
(8) The portable electronic device according to (1) above, that is a portable game device.
(9) The portable electronic device according to (1) above, that is an electronic dictionary.
(10) The portable electronic device according to (1) above, that is an electronic book.
(11) An adhesively double-faced PSA sheet having a PSA layer,

having an initial push-peel strength of 0.5 MPa or greater, and

having a push-peel strength at 24 hours after artificial sebum application, retaining at least 25% of the initial push-peel strength (having an adhesive strength retention rate of 25% or higher, determined as the ratio of the push-peel strength at 24 hours after artificial sebum application to the push-peel strength before the artificial sebum application).

(12) The PSA sheet according to (11) above, wherein the initial push-peel strength is 1 MPa or greater and the percent adhesive strength retained is 50% or higher.
(13) The PSA sheet according to (11) or (12) above, wherein the PSA layer comprises an acrylic polymer as the base polymer.
(14) The PSA sheet according to any of (11) to (13) above, wherein the PSA layer comprises a tackifier resin having a hydroxyl value of 120 mgKOH/g or greater.
(15) The PSA sheet according to (14) above, wherein the tackifier resin comprises a phenolic tackifier resin.
(16) The PSA sheet according to (14) or (15) above, wherein the tackifier resin content of the PSA layer is 10 parts by weight or greater and 60 parts by weight or less to 100 parts by weight of the base polymer of the PSA layer.
(17) The PSA sheet according to any of (11) to (16) above, having a substrate layer that supports the PSA layer.
(18) The PSA sheet according to (17) above, wherein the substrate layer includes a resin film layer or a foam layer.
(19) The PSA sheet according to any of (11) to (18) above, wherein

the PSA layer comprises an acrylic polymer as its base polymer, and

the acrylic polymer is formed from starting monomers of which more than 50% by weight is an alkyl (meth)acrylate having an alkyl group with 1 to 6 carbon atoms at its ester terminus.

(20) The PSA sheet according to any of (11) to (19) above, wherein

the PSA layer comprises an acrylic polymer as its base polymer, and

the acrylic polymer is formed from starting monomers that includes a carboxy group-containing monomer.

(21) The PSA sheet according to (20) above, wherein

the carboxy group-containing monomer accounts for 1% to 10% by weight of the starting monomers.

(22) The PSA sheet according to any of (11) to (21) above, wherein

the PSA layer is formed of a PSA composition that comprises an isocyanate-based crosslinking agent.

(23) The PSA sheet according to any of (11) to (22) above, wherein

the PSA layer has a glass transition temperature in a range between −25° C. and 25° C., determined from its peak temperature of tan δ.

(24) The PSA sheet according to any of (11) to (23) above, having a 180° peel strength of 15 N/20 mm or greater.
(25) The PSA sheet according to any of (11) to (24) above, comprising a foam substrate as a substrate layer that supports the PSA layer, wherein the foam substrate is a polyolefinic foam substrate.
(26) The PSA sheet according to any of (11) to (25) above, comprising a foam substrate as a substrate layer that supports the PSA layer, wherein the foam substrate has a density of 0.1 g/cm³ to 0.9 g/cm³.
(27) The PSA sheet according to any of (11) to (26) above, comprising a foam substrate as a substrate layer that supports the PSA layer, wherein the foam substrate has a mean pore diameter of 10 μm to 200 μm.
(28) The PSA sheet according to any of (11) to (27) above, comprising a foam substrate as a substrate layer that supports the PSA layer, wherein the foam substrate has a thickness of 0.05 mm to 0.70 mm.
(29) The PSA sheet according to any of (11) to (28) above, used for bonding components of a portable electronic device.
(30) A portable device having the PSA sheet according to any of (11) to (29) above and components bonded together with the PSA sheet.
(31) A PSA composition comprising an acrylic polymer as its base polymer and a tackifier resin, wherein the tackifier resin comprises a tackifier resin having a hydroxyl value of 120 mgKOH/g or greater.
(32) The PSA composition according to (31) above, wherein the tackifier resin comprises a phenolic tackifier resin.
(33) The PSA composition according to (31) or (32) above, wherein the tackifier resin content is 10 parts by weight or greater and 60 parts by weight or less to 100 parts by weight of the base polymer.
(34) The PSA composition according to any of (31) to (33) above, wherein the acrylic polymer is formed from starting monomers of which more than 50% by weight is an alkyl (meth)acrylate having an alkyl group with 1 to 6 carbon atoms at its ester terminus.
(35) The PSA composition according to any of (31) to (34) above, wherein the acrylic polymer is formed from starting monomers that includes a carboxy group-containing monomer.
(36) The PSA composition according to (35) above, wherein the carboxy group-containing monomer accounts for 1% to 10% by weight of the starting monomers.
(37) The PSA composition according to any of (31) to (36) above, comprising an isocyanate-based crosslinking agent.

### EXAMPLES

Several working examples related to the present invention are described below, but the present invention is not to be limited to these examples. In the description below, “parts” and “%” are by weight unless otherwise specified.

### <<Evaluation Methods>>

### [Initial Push-Peel Strength]

### (1) Preparation of Test Samples

A double-faced PSA sheet is cut into a 2 mm window frame shape (picture frame shape) measuring 20 mm both horizontally and vertically to obtain a double-faced PSA sheet frame 102. With the double-faced PSA sheet frame 102, an acrylic plate (PMMA plate) 103 (40 mm horizontally, 50 mm vertically, 2 mm thick) and an aluminum plate 101 (50 mm horizontally, 60 mm vertically, 2 mm thick) having a through hole of 12 mm diameter at the center are press-bonded together under a prescribed load (5 kg×10 sec) to obtain a test sample 100.

### (2) Determination of Initial Adhesive Strength

With respect to the resulting test sample, the push-peel strength is determined by the following method. In particular, as shown in FIG. 3, a test sample 100 is fixed to a support 125 and the resultant is set in a universal tensile/compression tester (model name TG-1kN available from Minebea Co., Ltd.), wherein test sample 100 is a laminate of aluminum plate 101, double-faced PSA sheet frame 102 and acrylic plate 103. Around rod 120 (diameter of contact area: 10 mm) is placed through the through hole 104 in aluminum plate 101 of test sample 100. Round rod 120 is lowered at a rate of 10 mm/min to push acrylic plate 103 in the direction away from aluminum plate 101. The maximum stress (N) prior to the separation of aluminum plate 101 and acrylic plate 103 is determined and the push-peel strength per unit contact area (N/mm²) is determined as the initial push-peel strength (MPa). The measurement is taken in an environment at 23° C., 50% RH.

[Push-Peel Strength after Artificial Sebum Application]

### (1) Preparation of Test Sample

A test sample is prepared in the same manner as the determination of the initial push-peel strength.

(2) Application of artificial sebum

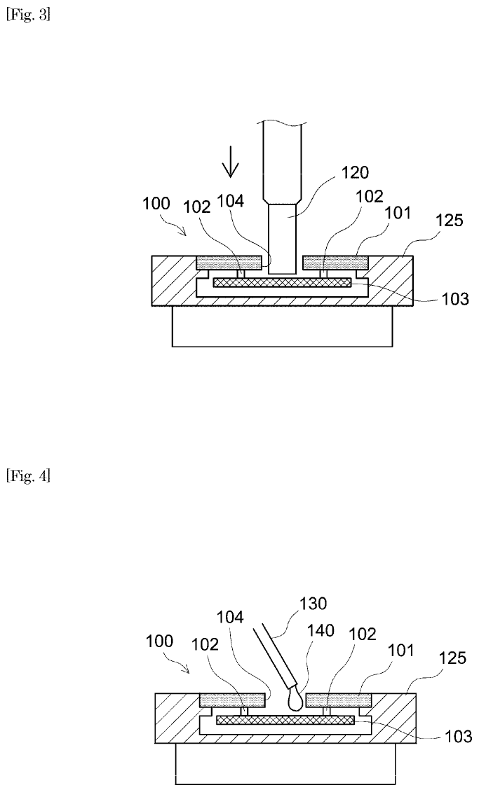

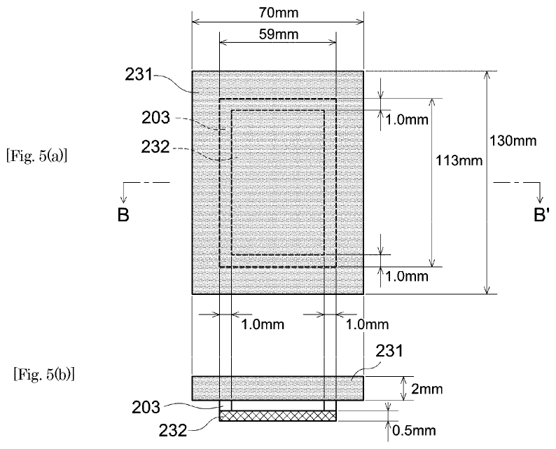

As shown in FIG. 4, test sample 100 is placed with the aluminum plate 101 side up. Using an injector 130, via through hole 104 in aluminum plate 101, 0.01 mL to 0.03 mL of artificial sebum 140 is dropped onto the bonding area of double-faced PSA sheet frame 102. The resulting test sample 100 having artificial sebum 140 is left standing in an environment at 55° C. and 95% RH (relative humidity) for 24 hours. The artificial sebum has a composition formed of 33.3% triolein, 20.0% oleic acid, 13.3% squalene and 33.4% myristyl octadecylate.

### (3) Determination of Push-Peel Strength

At 24 hours after the artificial sebum application, test sample 100 having artificial sebum 140 is subjected to measurement of post-sebum-application push-peel strength (MPa) by the same method as the measurement of initial push-peel strength.

### [180° Peel Strength]

In a measurement environment at 23° C. and 50% RH, one adhesive face of the double-faced PSA sheet is backed with 50 μm thick PET film applied thereto and cut into a 20 mm wide and 100 mm long size to prepare a test sample. In an environment at 23° C. and 50% RH, the other adhesive face of the test sample is press-bonded to the surface of a stainless steel (SUS304BA) plate with a 2 kg roller moved back and forth once. The resultant is left standing in the same environment for 30 minutes. Subsequently, using a universal tensile/compression test, based on JIS Z 0237:2000, the peel strength (N/20 mm) is determined at a tensile speed of 300 mm/min at a peel angle of 180°. As the universal tensile/compression tester, model name TG-1 kN available from Minebea Co., Ltd. or a comparable product is used.

### [Drop Impact Resistance Test]

The double-faced PSA sheet is cut into a 10 mm wide window frame (picture frame) shape measuring 59 mm horizontally and 113 mm vertically as shown in FIGS. 5(a)-(b) to obtain a double-faced PSA sheet frame. With the double-faced PSA sheet frame, a polycarbonate plate (70 mm horizontally, 130 mm vertically, 2 mm thick) and a glass plate (59 mm horizontally, 113 mm vertically, 0.5 mm thick) are bonded together under a 50 N load applied for 10 seconds to obtain a test sample.

FIGS. 5(a)-(b) outline the test sample, FIG. 5(a) in top view and 5(b) in B-B′ cross-sectional view. In FIGS. 5(a)-(b), reference numerals 203, 231 and 232 show the double-faced PSA sheet frame, polycarbonate plate and glass plate, respectively.

A 160 g weight is attached to the backside (opposite from the face bearing the glass plate) of the test sample's polycarbonate plate. The weight-bearing test sample is subjected to a drop test at room temperature (about 23° C.) where it is freely dropped from a height of 1.2 m onto a concrete board six times. For this, the spatial orientation of test sample is changed every time so that, of the six faces, a different face is on the bottom each time. In other words, for each of the six faces, one round of a single dropping pattern is carried out.

After each round of dropping, the state of bonding between the polycarbonate plate and glass plate is visually inspected and the number of rounds of dropping that the PSA sheet endures before the two plates peel off (separate) is evaluated as the drop impact resistance. When no peeling is observed after 6 rounds of dropping, a “Pass” is given.

### [Dynamic Viscoelastic Measurement]

To a release face of 38 μm thick PET film treated with a silicone-based release agent on one face, a PSA composition is applied and allowed to dry at 100° C. for two minutes to form a 50 μm thick PSA layer on the release face. Several pieces of the 50 μm thick PSA layer were layered to prepare a layered PSA sample of about 2 mm thickness. The layered PSA sample is punched in a disc shape of 7.9 mm diameter to obtain a specimen. The specimen is fastened between parallel plates and subjected to dynamic viscoelastic measurement using a rheometer (ARES available from TA Instruments) under the conditions shown below to determine the PSA layer's Tg (peak top temperature of tan δ) (° C.), peak strength at the tan δ peak, 25° C. storage modulus (MPa) and 25° C. loss modulus (MPa).

### [Measurement Conditions]

Measurement mode: shear mode

Temperature range: −70° C. to 150° C.

Heating rate: 5° C./min

Measurement frequency: 1 Hz

### Preparation of Acrylic Polymers

### Preparative Example 1

Into a reaction vessel equipped with a stirrer, thermometer, nitrogen inlet, condenser and dropping funnel, were placed 95 parts of BA and 5 parts of AA as starting monomers and 233 parts of ethyl acetate as the polymerization solvent. The resulting mixture was allowed to stir under a nitrogen flow for two hours to eliminate oxygen from the polymerization system. Subsequently, was added 0.2 part of AIBN as the polymerization initiator. The solution polymerization was carried out at 60° C. for eight hours to obtain a solution of acrylic polymer A1. The acrylic polymer A1 had a Mw of about 70×10⁴.

### Preparative Example 2

The monomer composition was changed to 100 parts of BA and 5 parts of AA, BPO was used as the polymerization initiator and toluene was used as the polymerization solvent, but otherwise in the same manner as Preparative Example 1, was obtained a solution of acrylic polymer A2. The acrylic polymer A2 had a Mw in a range between about 50×10⁴ and 60×10⁴.

### Preparative Example 3

The monomer composition was changed to 100 parts of BA, 5 parts of VAc, 3 parts of AA and 0.1 part of HEA, and toluene was used as the polymerization solvent, but otherwise in the same manner as Preparative Example 1, was obtained a solution of acrylic polymer A3. The acrylic polymer A3 had a Mw of about 50×10⁴.

### Preparative Example 4

The monomer composition was changed to 90 parts of 2EHA and 10 parts of AA and BPO was used as the polymerization initiator, but otherwise in the same manner as Preparative Example 1, was obtained a solution of acrylic polymer A4. The acrylic polymer A4 had a Mw of about 120×10⁴.

### Experiment 1

### Example 1-1

Were mixed and stirred 100 parts of acrylic polymer A1, 15 parts of tackifier resin B1 (product name HARITACK SE10 available from Harima Chemicals Group, Inc.; hydrogenated glycerin ester, softening point 75° C. to 85° C., hydroxyl value 25 mgKOH/g to 40 mgKOH/g) and 2 parts of isocyanate-based crosslinking agent (product name CORONATE L, 75% solution of trimethylol propane/tolylene diisocyanate trimer adduct in ethyl acetate, available from Nippon Polyurethane Industry Co., Ltd.) to prepare a PSA composition according to this Example.

The resulting PSA composition was applied to the release face of 38 μm thick polyester release film (product name DIAFOIL MRF available from Mitsubishi Polyester) and was allowed to dry at 100° C. for two minutes to form a 40 μm thick PSA layer. To this PSA layer, was adhered the release face of 25 μm thick polyester film (trade name DIAFOIL MRF available from Mitsubishi Polyester). A40 μm thick substrate-free double-faced PSA sheet was thus obtained, with the two faces protected with the two sheets of polyester release film.

### Example 1-2

Using tackifier resin B2 (product name SUMILITE RESIN PR-12603N available from Sumitomo Bakelite Co., Ltd.; terpene-modified phenolic resin, softening point 130° C. to 140° C., hydroxyl value 1 mgKOH/g to 20 mgKOH/g) in place of tackifier resin B1, but otherwise in the same manner as Example 1-1, was prepared a PSA composition according to this Example and obtained a substrate-free double-faced PSA sheet.

### Example 1-3

Using tackifier resin B3 (product name MIGHTY ACE G125 available from Yasuhara Chemical Co., Ltd.; terpene phenol resin, softening point 125° C., hydroxyl value 140 mgKOH/g) in place of tackifier resin B1, but otherwise in the same manner as Example 1-1, was prepared a PSA composition according to this Example and obtained a substrate-free double-faced PSA sheet.

### Example 1-4

Using tackifier resin B4 (product name YS POLYESTER available from Yasuhara Chemical Co., Ltd.; terpene phenol resin, softening point 145° C., hydroxyl value 70 mgKOH/g to 110 mgKOH/g) in place of tackifier resin B1, but otherwise in the same manner as Example 1-1, was prepared a PSA composition according to this Example and obtained a substrate-free double-faced PSA sheet.

### Example 1-5

The amount of tackifier resin B3 was changed to 30 parts, but otherwise in the same manner as Example 1-3, was prepared a PSA composition according to this Example and obtained a substrate-free double-faced PSA sheet.

### Example 1-6

The amount of tackifier resin B4 was changed to 30 parts, but otherwise in the same manner as Example 1-4, was prepared a PSA composition according to this Example and obtained a substrate-free double-faced PSA sheet.

### Example 1-7

Using acrylic polymer A2 in place of acrylic polymer A1, but otherwise in the same manner as Example 1-1, was prepared a PSA composition according to this Example and obtained a substrate-free double-faced PSA sheet.

### Example 1-8

Using tackifier resin B2 in place of tackifier resin B 1, but otherwise in the same manner as Example 1-7, was prepared a PSA composition according to this Example and obtained a substrate-free double-faced PSA sheet.

### Example 1-9

Using tackifier resin B3 in place of tackifier resin B1, but otherwise in the same manner as Example 1-7, was prepared a PSA composition according to this Example and obtained a substrate-free double-faced PSA sheet.

### Example 1-10

Using tackifier resin B4 in place of tackifier resin B1, but otherwise in the same manner as Example 1-7, was prepared a PSA composition according to this Example and obtained a substrate-free double-faced PSA sheet.

### Example 1-11

Using tackifier resin B5 (product name TAMANOL 803L available from Arakawa Chemical Industries, Ltd.; terpene phenol resin, softening point 145° C. to 160° C., hydroxyl value 1 mgKOH/g to 20 mgKOH/g) in place of tackifier resin B1, but otherwise in the same manner as Example 1-7, was prepared a PSA composition according to this Example and obtained a substrate-free double-faced PSA sheet.

### Example 1-12

The amount of tackifier resin B2 was changed to 30 parts, but otherwise in the same manner as Example 1-8, was prepared a PSA composition according to this Example and obtained a substrate-free double-faced PSA sheet.

### Example 1-13

The amount of tackifier resin B3 was changed to 30 parts, but otherwise in the same manner as Example 1-9, was prepared a PSA composition according to this Example and obtained a substrate-free double-faced PSA sheet.

### Example 1-14

In the same manner as Example 1-1, were mixed and stirred 100 parts of acrylic polymer A2 and 30 parts of tackifier resin B3 to prepare a PSA composition according to this Example.

Were obtained two sheets of commercial release liner (product name SLB-80W3D available from Sumika-kakoushi Co., Ltd.). To one face (release face) of each release liner, the PSA composition was applied and allowed to dry at 100° C. for two minutes to form a 40 μm thick PSA layer on the release face of each release liner. The resulting two PSA layers were adhered, respectively, to two faces of a polyethylene-based foam sheet (thickness 0.15 mm, density 0.56 g/cm³, 10% compressive strength (C₁₀) 167 kPa, 25% compressive strength (C₂₅) 468 kPa, 30% compressive strength (C₃₀) 627 kPa, mean pore diameter 55 μm) with the two faces pre-subjected to corona discharge treatment. The release liners were left as they were on the PSA layers to protect their surfaces (adhesive faces). The resulting structure was passed through a laminator at 80° C. (0.3 MPa, 0.5 m/min rate) once and then allowed to cure in an oven at 50° C. for one day. A PSA sheet (foam substrate-supported double-faced PSA sheet) was thus obtained according to this Example.

### Example 1-15

Using acrylic polymer A1 in place of acrylic polymer A2, but otherwise in the same manner as Example 1-14, was prepared a PSA composition according to this Example and obtained a foam substrate-supported double-faced PSA sheet.

### Example 1-16

Using acrylic polymer A3 in place of acrylic polymer A2, but otherwise in the same manner as Example 1-14, was prepared a PSA composition according to this Example and obtained a foam substrate-supported double-faced PSA sheet.

With respect to the PSA sheet of each Example, the initial push-peel strength (S1) (MPa) and 24-h post-sebum-application push-peel strength (S2) (MPa) were measured to determine the % adhesive strength (S2/S1) retained after artificial sebum application. The results are shown in Tables 1 and 2 along with the PSA compositions and overall sheet compositions.

TABLE 1

| | | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | | 1-1 | 1-2 | 1-3 | 1-4 | 1-5 | 1-6 | 1-7 | 1-8 | 1-9 | 1-10 | 1-11 | 1-12 | 1-13 |
| Configuration | | Substrate-free (40 μm thick) | | | | | | | | | | | | |
| Acrylic polymer (parts) | A1 | 100 | 100 | 100 | 100 | 100 | 100 | | | | | | | |
| | A2 | | | | | | | 100 | 100 | 100 | 100 | 100 | 100 | 100 |
| Tackifier resin (parts) | B1 | 15 | | | | | | 15 | | | | | | |
| | B2 | | 15 | | | | | | 15 | | | | 30 | |
| | B3 | | | 15 | | 30 | | | | 15 | | | | 30 |
| | B4 | | | | 15 | | 30 | | | | 15 | | | |
| | B5 | | | | | | | | | | | 15 | | |

| | | | | | | | | | | | | | |
|---|---|---|---|---|---|---|---|---|---|---|---|---|---|
| Initial push-peel strength S1 (Mpa) | 0.46 | 1.06 | 0.58 | 0.48 | 0.81 | 0.61 | 0.16 | 0.15 | 0.29 | 0.64 | 0.22 | 0.77 | 0.84 |
| 24 h post-sebum-application push-peel | 0.14 | 0.13 | 0.32 | 0.20 | 0.49 | 0.27 | 0 | 0.02 | 0.05 | 0.07 | 0.02 | 0.16 | 0.21 |
| strength S2 (Mpa) | | | | | | | | | | | | | |
| S2/S1 (%) | 31% | 13% | 55% | 42% | 61% | 44% | 3% | 17% | 18% | 10% | 9% | 20% | 25% |

TABLE 2

| | | Ex. 1-14 | Ex. 1-15 | Ex. 1-16 |
|---|---|---|---|---|
| Configuration | | Foam substrate-supported, | | |
| | | double-faced | | |
| Acrylic polymer (parts) | A1 | | 100 | |
| | A2 | 100 | | |
| | A3 | | | 100 |
| Tackifier resin (parts) | B3 | 30 | 30 | 30 |

| | | | |
|---|---|---|---|
| Initial push-peel strength S1 (Mpa) | 1.13 | 1.26 | 1.05 |
| 24 h post-sebum-application push- | 0.44 | 0.77 | 0.44 |
| peel strength S2 (Mpa) | | | |
| S2/S1 (%) | 39% | 61% | 42% |

As shown in Table 1, in Experiment 1, different species of acrylic polymer and tackifier resin were tested. Among tackifier resins B1 to B5, relatively highly reliable grease-resistant adhesions were obtained in Examples 1-3, 1-5, 1-9 and 1-13 using tackifier resin B3 and having compositions that include acrylic polymer A1 or A2 as the base polymer. As shown in Table 2, with respect to the foam substrate-supported double-faced PSA sheets using tackifier resin B3, both S1 and S2/S1 were higher as compared to the corresponding substrate-free PSA sheets. In particular, Example 1-15 using acrylic polymer A1 and tackifier resin B3 showed adhesive strength as high as or higher than 0.7 MPa both initially and after the artificial sebum application.

### Experiment 2

### Example 2-1

In the same manner as Example 1-3 in Experiment 1, using 100 parts of acrylic polymer A1 and 15 parts of tackifier resin B3, was prepared a PSA composition according to this Example. Using the resulting PSA composition, but otherwise in the same manner as Example 1-14 in Experiment 1, was obtained a PSA sheet (foam substrate-supported double-faced PSA sheet) having a PSA layer (40 μm thick) on each face of a polyethylene-based foam sheet (0.15 mm thick).

### Example 2-2

The amount of tackifier resin B3 was changed to 30 parts, but otherwise in the same manner as Example 2-1, was prepared a PSA composition according to this Example and obtained a foam substrate-supported double-faced PSA sheet.

### Example 2-3

Using tackifier resin B6 (product name YS POLYESTER N125 available from Yasuhara Chemical Co., Ltd.; terpene phenol resin, softening point 125° C., hydroxyl value 170 mgKOH/g) in place of tackifier resin B3, but otherwise in the same manner as Example 2-1, was prepared a PSA composition according to this Example and obtained a foam substrate-supported double-faced PSA sheet.

### Example 2-4

The amount of tackifier resin B6 was changed to 30 parts, but otherwise in the same manner as Example 2-3, was prepared a PSA composition according to this Example and obtained a foam substrate-supported double-faced PSA sheet.

### Example 2-5

Using tackifier resin B7 (product name MIGHTY ACE K125 available from Yasuhara Chemical Co., Ltd.; terpene phenol resin, softening point 125° C., hydroxyl value 200 mgKOH/g) in place of tackifier resin B3, but otherwise in the same manner as Example 2-1, was prepared a PSA composition according to this Example and obtained a foam substrate-supported double-faced PSA sheet.

### Example 2-6

The amount of tackifier resin B7 was changed to 30 parts, but otherwise in the same manner as Example 2-5, was prepared a PSA composition according to this Example and obtained a foam substrate-supported double-faced PSA sheet.

With respect to the PSA sheet of each Example, the initial push-peel strength (S1) (MPa) and 24-h post-sebum-application push-peel strength (S2) (MPa) were measured to determine the % adhesive strength (S2/S1) retained after artificial sebum application. In addition, with respect to the PSA layers of Examples 2-1, 2-2 and 2-6, the PSA layer's Tg (° C.), peak strength of tan δ (G″/G′), 25° C. storage modulus (G′(25° C.)) (MPa) and 25° C. loss modulus (G″(25° C.)) (MPa) were determined. The results are shown in Table 3 along with the PSA compositions and overall sheet compositions.

TABLE 3

| | | Ex. 2-1 | Ex. 2-2 | Ex. 2-3 | Ex. 2-4 | Ex. 2-5 | Ex. 2-6 |
|---|---|---|---|---|---|---|---|
| Configuration | | Foam substrate-supported, double-faced | | | | | |
| Acrylic polymer (parts | A1 | 100 | 100 | 100 | 100 | 100 | 100 |
| Tackifier resin (parts) | B3 | 15 | 30 | | | | |
| | B6 | | | 15 | 30 | | |
| | B7 | | | | | 15 | 30 |
| PSA layer | Tg [° C.] | −8.6 | 4.7 | — | — | — | 7.3 |
| | tanδ peak strength | 1.92 | 2.12 | — | — | — | 2.26 |
| | G′(25° C.) (Mpa) | 0.14 | 0.20 | — | — | — | 0.24 |
| | G″(25° C.) (Mpa) | 0.07 | 0.19 | — | — | — | 0.24 |

| | | | | | | |
|---|---|---|---|---|---|---|
| Initial push-peel strength S1 (Mpa) | 1.08 | 1.26 | 1.09 | 1.15 | 1.11 | 1.36 |
| 24 h post-sebum-application push-peel | 0.59 | 0.77 | 0.64 | 0.88 | 0.87 | 1.11 |
| strength S2 (M | | | | | | |
| S2/S1 (%) | 55% | 61% | 59% | 77% | 78% | 82% |

### Experiment 3

### Example 3-1

Were mixed and stirred 100 parts of acrylic polymer A4, 20 parts of tackifier resin B5 and 0.05 part of epoxy-based crosslinking agent (product name TETRAD-C, 1,3-bis(N,N-diglycidylaminomethyl)cyclohexane, available from Mitsubishi Gas Chemical Co., Inc.) to prepare a PSA composition of this Example.

Using the resulting PSA composition, but otherwise in the same manner as Example 1-14 in Experiment 1, was obtained a PSA sheet (foam substrate-supported double-faced PSA sheet) having a PSA layer (40 μm thick) on each face of a polyethylene-based foam sheet (0.15 mm thick).

### Example 3-2

Were mixed and stirred 100 parts of acrylic polymer A1, 30 parts of tackifier resin B7 and 2 parts of isocyanate-based crosslinking agent (product name CORONATE L, 75% solution of trimethylol propane/tolylene diisocyanate trimer adduct in ethyl acetate, available from Nippon Polyurethane Industry Co., Ltd.) to prepare a PSA composition according to this Example. Using the resulting PSA composition, but otherwise in the same manner as Example 3-1, was obtained a foam substrate-supported double-faced PSA sheet.

### Example 3-3

Using 100 parts of acrylic polymer A1 and 30 parts of tackifier resin B4, but otherwise in the same manner as Example 3-2, was obtained a foam substrate-supported double-faced PSA sheet.

With respect to the PSA sheet of each Example, the initial push-peel strength (S1) (MPa) and 24-h post-sebum-application push-peel strength (S2) (MPa) were measured to determine the % adhesive strength (S2/S1) retained after artificial sebum application. The results are shown in Table 4 along with the PSA compositions and overall sheet compositions.

TABLE 4

| | | Ex. 3-1 | Ex. 3-2 | Ex. 3-3 |
|---|---|---|---|---|
| Configuration | | Foam substrate-supported, | | |
| | | double-faced | | |
| Acrylic polymer (parts) | A1 | | 100 | 100 |
| | A4 | 100 | | |
| Tackifier resin (parts) | B4 | | | 30 |
| | B5 | 20 | | |
| | B7 | | 30 | |

| | | | |
|---|---|---|---|
| Initial push-peel strength S1 (Mpa) | 1.36 | 1.36 | 0.93 |
| 24 h post-sebum-application push-peel | 0.10 | 1.11 | 0.40 |
| strength S2 (Mpa) | | | |
| S2/S1 (%) | 8% | 82% | 43% |

In Experiment 2, studies were conducted on the use of high-OH tackifier resin. As shown in Table 3, with increasing hydroxyl value, the post-sebum-application adhesive strength retention rate showed a tendency to increase. In the embodiment using a high-OH resin, with its increasing content, both the initial push-peel strength and the post-sebum-application adhesive strength retention rate increased. In Experiment 3, studies were conducted on foam substrate-supported PSA sheets using tackifier resin B4, B5 or B7. As shown in Table 4, the highest post-sebum-application adhesive strength retention rate was obtained in Example 3-2 using tackifier resin B7 (hydroxyl value 200 mgKOH/g). The next highest rate was obtained in Example 3-3 using tackifier resin B4 (hydroxyl value 70 mgKOH/g to 110 mgKOH/g). These results indicate that the tackifier resin's hydroxyl value and its amount contained contribute to an increase in grease resistance.

It is noted that Experiments 1 to 3 and Experiment 4 described below were carried out at different times; and because it is difficult to reproduce the exact sample preparations and test conditions (operators, experimental environments, etc.), comparison within each Experiment and comparison among Experiments should not be treated equally.

### Experiment 4

### Example 4-1

Were mixed and stirred 100 parts of acrylic polymer A1, 30 parts of tackifier resin B7 and 2 parts of isocyanate-based crosslinking agent (product name CORONATE L, 75% solution of trimethylol propane/tolylene diisocyanate trimer adduct in ethyl acetate, available from Nippon Polyurethane Industry Co., Ltd.) to prepare a PSA composition according to this Example. Using the resulting PSA composition, but otherwise in the same manner as Example 1-14 in Experiment 1, was obtained a PSA sheet (foam substrate-supported double-faced PSA sheet) having a PSA layer (40 μm thick) on each face of a polyethylene-based foam sheet (0.15 mm thick).

### Example 4-2

The amount of tackifier resin B7 was changed to 40 parts and 0.02 part of epoxy-based crosslinking agent (product name TETRAD-C, 1,3-bis(N,N-diglycidylaminomethyl)cyclohexane, available from Mitsubishi Gas Chemical Co., Inc.) was added as the crosslinking agent in addition to the isocyanate-based crosslinking agent relative to 100 parts of acrylic polymer, but otherwise in the same manner as Example 4-1, was prepared a PSA composition according to this Example and obtained a foam substrate-supported double-faced PSA sheet.

### Example 4-3

The amount of tackifier resin B7 was changed to 40 parts, but otherwise in the same manner as Example 4-1, was prepared a PSA composition according to this Example and obtained a foam substrate-supported double-faced PSA sheet.

### Example 4-4

The amount of tackifier resin B7 was changed to 70 parts, but otherwise in the same manner as Example 4-1, was prepared a PSA composition according to this Example and obtained a foam substrate-supported double-faced PSA sheet.

### Example 4-5

Using 12 μm thick PET film (product name LUMIRROR available from Toray Industries, Inc.) as the substrate in place of the polyethylene-based foam sheet, but otherwise in the same manner as Example 4-1, was prepared a PSA composition according to this Example and obtained a foam substrate-supported double-faced PSA sheet.

With respect to the PSA sheet of each Example, were measured the 180° peel strength (N/20 mm), initial push-peel strength (S1) (MPa) and 24-h post-sebum-application push-peel strength (S2) (MPa) and the % adhesive strength (S2/S1) retained after artificial sebum application was determined. The results are shown in Table 5 along with the PSA compositions and overall sheet compositions.

TABLE 5

| | | Ex. 4-1 | Ex. 4-2 | Ex. 4-3 | Ex. 4-4 | Ex. 4-5 |
|---|---|---|---|---|---|---|
| Configuration | | Foam substrate-supported, double-faced | | | | PET substrate- |
| | | | | | | supported, |
| | | | | | | double-faced |
| Acrylic polymer (parts) | A1 | 100 | 100 | 100 | 100 | 100 |
| Tackifier resin (parts) | B7 | 30 | 40 | 40 | 70 | 30 |
| Crosslinking agent (parts) | Isocyanate-based | 2 | 2 | 2 | 2 | 2 |
| | Epoxy-based | | 0.02 | | | |

| | | | | | |
|---|---|---|---|---|---|
| 180° Peel strength (N/20 mm) | 20 | 19 | 19 | 12 | 20 |
| Initial push-peel | 1.36 | 1.43 | 1.31 | 0.88 | 0.66 |
| strength S1 (Mpa) | | | | | |
| 24 h post-sebum-application push-peel | 1.11 | 0.76 | 1.13 | 0.75 | 0.53 |
| strength S2 (M | | | | | |
| S2/S1 (%) | 82% | 53% | 86% | 85% | 79% |

With respect to PSA compositions as mixtures of high-OH tackifier resin B7 and acrylic polymer A1, studies were conducted on the use of foam substrate. In each Example, as shown in Table 5, good results were obtained in initial push-peel strength and % adhesive strength retained after artificial sebum application. In particular, excellent results were obtained in Examples 4-1 and 4-3. While not shown in Table 5, the PSA sheet of Example 4-1 was subjected to the drop impact resistance test and showed a good result.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 2 PSA sheets
10 support substrate
10A first face
10B second face
21 first PSA layer
22 second PSA layer
21A first adhesive face
22A second adhesive face
31, 32 release liners

What is claimed is:

1. A portable electronic device having a touch panel whose display also serves as an input device, wherein
the touch panel can be operated by direct finger touch,
the portable electronic device has components bonded with a pressure-sensitive adhesive sheet
the pressure-sensitive adhesive sheet is an adhesively double-faced PSA sheet having a pressure-sensitive adhesive layer,
the pressure-sensitive adhesive sheet has an initial push-peel strength of 0.5 MPa or greater,
the pressure-sensitive adhesive sheet has a push-peel strength at 24 hours after artificial sebum application, retaining at least 25% of the initial push-peel strength.

2. The portable electronic device according to claim 1, that is a portable phone.

3. The portable electronic device according to claim 1, that is a smartphone.

4. The portable electronic device according to claim 1, that is a tablet PC.

5. The portable electronic device according to claim 1, that is a wearable device.

6. The portable electronic device according to claim 1, that is a digital camera.

7. The portable electronic device according to claim 1, that is a portable music player.

8. The portable electronic device according to claim 1, that is a portable game device.

9. The portable electronic device according to claim 1, that is an electronic dictionary.

10. The portable electronic device according to claim 1, that is an electronic book.

11. An adhesively double-faced pressure-sensitive adhesive sheet having a pressure-sensitive adhesive layer,
having an initial push-peel strength of 0.5 MPa or greater, and
having a push-peel strength at 24 hours after artificial sebum application, retaining at least 25% of the initial push-peel strength.

12. The pressure-sensitive adhesive sheet according to claim 11, wherein the initial push-peel strength is 1 MPa or greater and the percent adhesive strength retained is 50% or higher.

13. The pressure-sensitive adhesive sheet according to claim 11, wherein the pressure-sensitive adhesive layer comprises an acrylic polymer as its base polymer.

14. The pressure-sensitive adhesive sheet according to claim 11, wherein the pressure-sensitive adhesive layer comprises a tackifier resin having a hydroxyl value of 120 mgKOH/g or greater.

15. The pressure-sensitive adhesive sheet according to claim 14, wherein the tackifier resin comprises a phenolic tackifier resin.

16. The pressure-sensitive adhesive sheet according to claim 14, wherein the tackifier resin content of the pressure-sensitive adhesive layer is 10 parts by weight or greater and 60 parts by weight or less to 100 parts by weight of the base polymer of the pressure-sensitive adhesive layer.

17. The pressure-sensitive adhesive sheet according to claim 11, having a substrate layer that supports the pressure-sensitive adhesive layer.

18. The pressure-sensitive adhesive sheet according to claim 17, wherein the substrate layer includes a resin film layer or a foam layer.

19. The pressure-sensitive adhesive sheet according to claim 11, used for bonding components of a portable electronic device.

20. A pressure-sensitive adhesive composition comprising an acrylic polymer as its base polymer and a tackifier resin, wherein
the tackifier resin comprises a tackifier resin having a hydroxyl value of 120 mgKOH/g or greater.
